(19) United States
(12) Patent Application Publication
(10) Pub. No.: US 2023/0110936 A1
(43) Pub. Date: Apr. 13, 2023

(54) BACTERIAL NANOCELLULOSE TRANSPARENT FILM, MANUFACTURING METHOD THEREOF, AND PACKAGING MATERIAL USING THE SAME

(71) Applicant: KOREA RESEARCH INSTITUTE OF CHEMICAL TECHNOLOGY, Daejeon (KR)

(72) Inventors: Jihoon SHIN, Daejeon (KR); Sae Hume PARK, Daejeon (KR); Jeong suk YUK, Daejeon (KR); Hyun Ho LEE, Daejeon (KR)

(73) Assignee: KOREA RESEARCH INSTITUTE OF CHEMICAL TECHNOLOGY, Daejeon (KR)

(21) Appl. No.: 17/951,317

(22) Filed: Sep. 23, 2022

(30) Foreign Application Priority Data
Sep. 23, 2021 (KR) 10-2021-0125890

(51) Int. Cl. C08J 5/04; C08J 5/18; C08L 1/02

(52) U.S. Cl. CPC C08J 5/045; C08J 5/18; C08L 1/02; C08J 2301/02; B82Y 30/00

(57) ABSTRACT

Provided are a bacterial nanocellulose transparent film, a manufacturing method thereof, and a packaging material including a food packaging material or an electronic product packaging material using the same capable of newly manufacturing a bacterial nanocellulose transparent film with an oxygen barrier property, a moisture barrier property, or a UV barrier property by performing electron beam irradiation and a film process on bacterial cellulose.

### CROSS-REFERENCE TO RELATED APPLICATIONS

This application claims the priority of Korean Patent Application No. 10-2021-0125890 filed on Sep. 23, 2021, in the Korean Intellectual Property Office, the disclosure of which is incorporated herein by reference.

### BACKGROUND OF THE INVENTION

### Field of the Invention

The present disclosure relates to a bacterial nanocellulose transparent film, a manufacturing method thereof, and a packaging material using the same, and more particularly, to a bacterial nanocellulose transparent film capable of newly manufacturing a bacterial nanocellulose transparent film having an oxygen barrier property, a moisture barrier property, or a UV barrier property by performing electron beam irradiation and a film process on bacterial cellulose, a manufacturing method thereof, and a packaging material of a food packaging material or an electronic product packaging material using the same.

### Description of the Related Art

In general, bacterial cellulose, unlike woody cellulose, consists of only cellulose with almost no by-products such as hemicellulose and lignin.

The bacterial cellulose is a bottom-up process that is produced from glucose monomolecules into cellulose by bacteria.

Characteristics of the bacterial cellulose include a high degree of crystallization, a three-dimensional network structure, high mechanical properties, excellent moisture containing capacity, and the like. By using these properties, foods, cosmetics, wound dressings, artificial cartilage tissue, and the like have been used and studied.

The bacterial cellulose is also called nanocellulose. This is because the bacterial cellulose exists in the form of fibers with a width of 100 nm or less. However, the length and the width are not uniform.

Therefore, research on preparing uniform bacterial nanocellulose through mechanical treatment or chemical treatment has been conducted. In the case of bacterial cellulose having a uniform length, the length thereof is longer than that of nanocellulose prepared by the same treatment as other woody celluloses, and thus the bacterial cellulose has high mechanical property values.

Through various studies, the present applicants newly manufactured a bacterial nanocellulose transparent film having an oxygen barrier property, a moisture barrier property, or a UV barrier property by performing electron beam irradiation and a film process on bacterial cellulose, acquired a method of using the bacterial nanocellulose transparent film as a packaging material of a food packaging material or an electronic product packaging material, and then completed the present disclosure.

### SUMMARY OF THE INVENTION

An object of the present disclosure is to provide a bacterial nanocellulose transparent film having an oxygen barrier property, a moisture barrier property, or a UV barrier property by electron beam irradiation, mechanical treatment, and a film process of vacuum filtration, oven drying, alkali treatment and bleaching treatment on bacterial cellulose.

Another object of the present disclosure is to provide bacterial nanocellulose consisting of cellulose nanofibers prepared by irradiating bacterial cellulose with radiation.

Yet another object of the present disclosure is to provide a manufacturing method of a bacterial nanocellulose transparent film using bacterial nanocellulose consisting of cellulose nanofibers.

Still another object of the present disclosure is to provide a packaging material of a food packaging material or an electronic product packaging material using a bacterial nanocellulose transparent film.

The objects of the present disclosure are not limited to the aforementioned object, and other objects, which are not mentioned above, will be apparent to those skilled in the art from the following description.

To solve the problems, according to an aspect of the present disclosure, there is provided a bacterial nanocellulose transparent film having a barrier property formed by a transparent film with a multilayer structure of bacterial nanocellulose, wherein the bacterial nanocellulose may be formed by electron beam irradiation and mechanical treatment on wet bacterial cellulose, the bacterial nanocellulose may comprise nanocellulose consisting of cellulose nanofibers (CNF) aggregated with one or more cellulose nanofibrils, the cellulose nanofibers (CNF) may include a carboxylate group, the multilayer structure of the transparent film may be formed by filtering and drying a dispersion of the bacterial nanocellulose, the transparent film may be alkali-treated and bleached to increase a mechanical property and a transparency, the mechanical property includes an Young's modulus, a tensile stress, or a tensile strain, and the barrier property of the transparent film may include an oxygen barrier property, a moisture barrier property, or a UV barrier property.

In an embodiment of the present disclosure, the transmittance at 400 nm to 600 nm of the bacterial nanocellulose transparent film may be 50% to 90%.

In an embodiment of the present disclosure, in the oxygen barrier property of the bacterial nanocellulose transparent film, an oxygen transmission rate (OTR) (cm³/m²·24 h·atm) may be 2.0 to 110 at 23° C. and 0% relative humidity.

In an embodiment of the present disclosure, as a moisture barrier property index, the swelling ratio before and after immersion in water of the bacterial nanocellulose transparent film may be 100% to 250%.

In an embodiment of the present disclosure, a UV-A (315 to 400 nm) transmittance of the bacterial nanocellulose transparent film used as a UV barrier property index may be 3% to 60%.

In an embodiment of the present disclosure, after irradiating artificial skin covered with the bacterial nanocellulose transparent film with a UV lamp of 365 nm used as a UV barrier property index for 72 hours, the change in thickness of the epidermal layer of the artificial skin may be increased 1.05 times to 1.20 times.

In an embodiment of the present disclosure, the Young's modulus may be 6.6 GPa to 10.0 GPa, the tensile stress may be 80 MPa to 200 MPa, or the tensile strain may be 1% to 20%.

In an embodiment of the present disclosure, the cellulose nanofibers (CNF) may include a crystalline portion and an amorphous portion constituting a crystal system, and the cellulose nanofibers (CNF) may have a diameter of 2 nm to 40 nm and a length of 500 nm to 20 μm.

In an embodiment of the present disclosure, the bacterial nanocellulose may exhibit a zeta potential of −50 mV to +50 mV.

In an embodiment of the present disclosure, the bacterial nanocellulose may have a light transmittance at 400 nm to 600 nm of 80% to 98%.

In an embodiment of the present disclosure, a degree of polymerization (DP) of the bacterial nanocellulose may be 1 to 200.

In an embodiment of the present disclosure, the carboxylate group may be a carboxylate group at the sixth carbon position (C6) of the cellulose nanofibers (CNF).

In an embodiment of the present disclosure, the shape of the cellulose nanofibers may be at least one shape selected from the group consisting of filament fibers, staple fibers, needle fibers, entangled fibers, and linear fibers.

In an embodiment of the present disclosure, the bacterial nanocellulose transparent film may be a transparent film with a multilayer structure of bacterial nanocellulose, wherein

the bacterial nanocellulose is formed by electron beam irradiation and mechanical treatment on wet bacterial cellulose,

the cellulose nanofibers (CNF) have a carboxylate group, and

the cellulose nanofibers (CNF) have a diameter of 2 nm to 40 nm and a length of 500 nm to 20 μm.

In an embodiment of the present disclosure, a suspension of the bacterial nanocellulose may be re-dried to a powder through a spray dryer, the powder of the dried bacterial nanocellulose is redispersed from a powder to a dispersion.

According to another aspect of the present disclosure, there is provided a bacterial nanocellulose consisting of cellulose nanofibers (CNF) aggregated with one or more cellulose nanofibrils, wherein the bacterial nanocellulose may be formed by electron beam irradiation and mechanical treatment on wet bacterial cellulose, the cellulose nanofibers (CNF) may include a carboxylate group, and the cellulose nanofibers (CNF) may have a diameter of 2 nm to 40 nm and a length of 500 nm to 20 μm.

In an embodiment of the present disclosure, a suspension of the bacterial nanocellulose may be re-dried to a powder through a spray dryer, the powder of the dried bacterial nanocellulose may be redispersed from a powder to a dispersion.

In an embodiment of the present disclosure, the cellulose nanofibers (CNF) may include a crystalline portion and an amorphous portion constituting a crystal system, and the cellulose nanofibers (CNF) may have a diameter of 2 nm to 40 nm and a length of 500 nm to 20 μm.

In an embodiment of the present disclosure, the bacterial nanocellulose may exhibit a zeta potential of −50 mV to +50 mV.

In an embodiment of the present disclosure, the bacterial nanocellulose may have a light transmittance at 400 nm to 600 nm of 80% to 98%.

In an embodiment of the present disclosure, a degree of polymerization (DP) of the bacterial nanocellulose may be 1 to 200.

In an embodiment of the present disclosure, the carboxylate group may be a carboxylate group at the sixth carbon position (C6) of the cellulose nanofibers (CNF).

In an embodiment of the present disclosure, the shape of the cellulose nanofibers may be at least one shape selected from the group consisting of filament fibers, staple fibers, needle fibers, entangled fibers, and linear fibers.

According to yet another aspect of the present disclosure, there is provided a manufacturing method of a bacterial nanocellulose transparent film comprising: (1) preparing a bacterial nanocellulose dispersion consisting of cellulose fibers (CNF) having a carboxylate group by irradiating electron beam on wet bacterial cellulose; and (2) forming a bacterial nanocellulose transparent film by vacuum filtration and oven drying of the bacterial nanocellulose dispersion.

In an embodiment of the present disclosure, the preparing of the bacterial nanocellulose dispersion in step (1) may comprise (a) separating the wet bacterial cellulose into cellulose fibers containing a carboxylate group by irradiating the electron beam; (b) alkalizing the cellulose fibers containing the carboxylate group by adding an alkali compound; (c) preparing cellulose nanofibers having a carboxylate group by separating the alkalized cellulose fibers having the carboxylate group with a high-pressure machine; and (d) preparing a nanocellulose dispersion consisting of cellulose nanofibers (CNF) having a carboxylate group by adding carbon dioxide (CO₂) to the cellulose nanofibers having the carboxylate group, neutralizing and centrifuging.

In an embodiment of the present disclosure, the forming of the bacterial nanocellulose transparent film in step (2) may further comprise oven-drying the bacterial nanocellulose dispersion, alkali-treating by adding an alkali compound, and then bleaching.

In an embodiment of the present disclosure, the beam intensity of the electron beam may be 200 kGy to 3000 kGy.

In an embodiment of the present disclosure, the manufacturing method of the bacterial nanocellulose transparent film may be a manufacturing method of a bacterial nanocellulose transparent film with a multilayer structure of the bacterial nanocellulose after a preparation method of bacterial nanocellulose consisting of cellulose nanofibers, the preparation method of bacterial nanocellulose consisting of cellulose nanofibers comprising:

(1) separating bacterial cellulose fibers (BCF) having a carboxylate group from the bacterial cellulose by irradiating electron beam to wet bacterial cellulose;

(2) alkalizing the bacterial cellulose fibers having the carboxylate group by adding an alkali compound;

(3) preparing bacterial cellulose nanofibers having a carboxylate group by separating the alkalized bacterial cellulose fibers (BCF) having the carboxylate group with a high-pressure machine device;

(4) preparing a bacterial nanocellulose dispersion consisting of bacterial cellulose nanofibers (BCNF) having a carboxylate group by adding carbon dioxide (CO₂) to the bacterial cellulose nanofibers having the carboxylate group, neutralizing and centrifuging; and

(5) preparing bacterial nanocellulose consisting of the bacterial cellulose nanofibers (BCNF) having the carboxylate group by drying the bacterial nanocellulose dispersion.

According to yet another aspect of the present disclosure, there is provided a preparation method of bacterial nanocellulose consisting of cellulose nanofibers comprising: (1) separating bacterial cellulose fibers (BCF) having a carboxylate group from the bacterial cellulose by irradiating electron beam to wet bacterial cellulose; (2) alkalizing the bacterial cellulose fibers having the carboxylate group by adding an alkali compound; (3) preparing bacterial cellulose nanofibers (BCNF) having a carboxylate group by separating the alkalized bacterial cellulose fibers (BCF) having the carboxylate group with a high-pressure machine device; (4) preparing a bacterial nanocellulose dispersion consisting of bacterial cellulose nanofibers (BCNF) having a carboxylate group by adding carbon dioxide (CO₂) to the bacterial cellulose nanofibers having the carboxylate group, neutralizing and centrifuging; and (5) preparing bacterial nanocellulose consisting of the bacterial cellulose nanofibers (BCNF) having the carboxylate group by drying the bacterial nanocellulose dispersion.

In an embodiment of the present disclosure, the beam intensity of the electron beam may be 200 kGy to 3000 kGy.

According to still another aspect of the present disclosure, there is provided a packaging material including a food packaging material or an electronic product packaging material using a bacterial nanocellulose transparent film.

According to the present disclosure, the bacterial nanocellulose film manufactured through electron beam irradiation is transparent and has an oxygen barrier property, a moisture resistance or a UV barrier property and excellent physical properties to be used for a food packaging material.

In addition, since the manufacturing method of the bacterial nanocellulose transparent film of the present disclosure is a process of performing a film process with a chemical material that is not harmful to a bacterial nanocellulose dispersion, the method is eco-friendly and the process is relatively simple and economical.

In addition, since the bacterial nanocellulose transparent film of the present disclosure may be variously applied to packaging materials including a food packaging material or an electronic product packaging material, there is an advantage that the scope of application is various.

It should be understood that the effects of the present disclosure are not limited to the effects, but include all effects that can be deduced from the detailed description of the present disclosure or configurations of the present disclosure described in appended claims.

### BRIEF DESCRIPTION OF THE DRAWINGS

FIG. 1 is a schematic diagram of a process of preparing bacterial nanocellulose consisting of cellulose nanofibers by irradiating bacterial cellulose with electron beam and then separating the bacterial cellulose by a high-pressure mechanical device.

FIG. 2 is a schematic diagram of a process of manufacturing a bacterial nanocellulose transparent film with high light transmittance by alkali-treating and bleaching a bacterial nanocellulose dispersion.

FIG. 3 is a graph showing a correlation between a carboxyl group content and a degree of polymerization when wet bacterial cellulose is irradiated with electron beam.

FIG. 4 illustrates FT-IR data of a bacterial cellulose raw material and bacterial cellulose irradiated with electron beam.

FIG. 5A shows TEM images of bacterial nanocellulose irradiated with 100 kGy electron beam, FIG. 5B shows TEM images of bacterial nanocellulose irradiated with 300 kGy electron beam, and FIG. 5C shows TEM images of bacterial nanocellulose irradiated with 500 kGy electron beam.

FIG. 6A shows a UV-Vis transmittance graph of a bacterial nanocellulose dispersion and FIG. 6B shows a Zeta potential graph of a bacterial nanocellulose dispersion.

FIG. 7 shows an XRD graph of freeze-dried bacterial nanocellulose powder.

FIG. 8 shows a TGA graph of bacterial nanocellulose subjected to electron beam irradiation and mechanical treatment.

FIG. 9 shows SEM images of bacterial nanocellulose and redispersion experiment result images after (a) 1 minute ultrasonication and (b) 3 minute ultrasonication.

FIG. 10A shows images of a film (E-BC-100 R), a film (E-BC-100 A), and a film (E-BC-100 A/B), FIG. 10B shows images of a film (E-BC-300 R), a film (E-BC-300 A), and a film (E-BC-300 A/B), and FIG. 10C shows images of a film (E-BC-500 R), a film (E-BC-500 A), and a film (E-BC-500 A/B).

FIG. 11 shows a UV-Vis transmittance graph of a bacterial nanocellulose transparent film.

FIG. 12A shows UV-Vis absorption spectra graphs of bacterial nanocellulose transparent films formed by irradiating 100 kGy electron beam, FIG. 12B shows UV-Vis absorption spectra graphs of bacterial nanocellulose transparent films formed by irradiating 300 kGy electron beam, and FIG. 12C shows UV-Vis absorption spectra graphs of bacterial nanocellulose transparent films formed by irradiating 500 kGy electron beam.

FIG. 13A shows XRD graphs of bacterial nanocellulose raw films, alkali-treated bacterial nanocellulose films and alkali-treated and bleached bacterial nanocellulose films formed by irradiating 100 kGy electron beam, FIG. 13B shows XRD graphs of bacterial nanocellulose raw films, alkali-treated bacterial nanocellulose films and alkali-treated and bleached bacterial nanocellulose films formed by irradiating 300 kGy electron beam, and FIG. 13C shows XRD graphs of bacterial nanocellulose raw films, alkali-treated bacterial nanocellulose films and alkali-treated and bleached bacterial nanocellulose films formed by irradiating 500 kGy electron beam.

FIG. 14A shows TGA graphs of a bacterial nanocellulose raw film, an alkali-treated bacterial nanocellulose film, and an alkali-treated and bleached bacterial nanocellulose film and FIG. 14B shows DTA graphs of a bacterial nanocellulose raw film, an alkali-treated bacterial nanocellulose film, and an alkali-treated and bleached bacterial nanocellulose film.

FIG. 15A shows Stress graphs of a TOCN film, a bacterial nanocellulose raw film, an alkali-treated bacterial nanocellulose film, and an alkali-treated and bleached bacterial nanocellulose film, FIG. 15B shows Strain graphs of a TOCN film, a bacterial nanocellulose raw film, an alkali-treated bacterial nanocellulose film, and an alkali-treated and bleached bacterial nanocellulose film, and FIG. 15C shows Young's modulus graphs of a TOCN film, a bacterial nanocellulose raw film, an alkali-treated bacterial nanocellulose film, and an alkali-treated and bleached bacterial nanocellulose film.

FIG. 16 shows a swelling test image of a TOCN film and a bacterial nanocellulose film.

FIG. 17A shows oxygen transmission rate (OTR) graphs of a TOCN film, a bacterial nanocellulose raw film, an alkali-treated bacterial nanocellulose film, and an alkali-treated and bleached bacterial nanocellulose film and FIG. 17B shows oxygen permeability (OP) graphs of a TOCN film, a bacterial nanocellulose raw film, an alkali-treated bacterial nanocellulose film, and an alkali-treated and bleached bacterial nanocellulose film.

FIG. 18 shows oxygen transmission rate (OTR) range graphs of a bacterial nanocellulose transparent film and various plastic films.

FIG. 19 shows UV-Vis transmittance spectra graphs of a TOCN film, a bacterial nanocellulose raw film, an alkali-treated bacterial nanocellulose film, and an alkali-treated and bleached bacterial nanocellulose film.

FIG. 20A shows images measured thickness changes of the epidermal layers of artificial skin not irradiated with a UV lamp of 365 nm used as a UV barrier property index, FIG. 20B shows images measured thickness changes of artificial skin irradiated with the UV lamp of 365 nm, FIG. 20C shows images measured thickness changes of artificial skin covered with a TOCN film irradiated with the UV lamp of 365 nm, and FIG. 20D shows images measured thickness changes of artificial skin covered with an alkali-treated and bleached bacterial nanocellulose film irradiated with the UV lamp of 365 nm for 72 hours.

### DETAILED DESCRIPTION OF THE PREFERRED EMBODIMENT

Hereinafter, preferred embodiments of the present disclosure will be described in detail with reference to the accompanying drawings.

Advantages and features of the present disclosure, and methods for accomplishing the same will be more clearly understood from exemplary embodiments to be described below in detail with reference to the accompanying drawings.

However, the present disclosure is not limited to the following exemplary embodiments but may be implemented in various different forms. The exemplary embodiments are provided only to make description of the present disclosure complete and to fully provide the scope of the present disclosure to a person having ordinary skill in the art to which the present disclosure pertains with the category of the invention, and the present disclosure will be defined by the appended claims.

In the following description of the present disclosure, a detailed description of known arts related thereto will be omitted when it is determined to make the subject matter of the present disclosure rather unclear.

Hereinafter, the present disclosure will be described in detail.

Bacterial Nanocellulose Transparent Film

A bacterial nanocellulose film manufactured through electron beam irradiation of the present disclosure is transparent and has an oxygen barrier property, a moisture resistance or a UV barrier property and excellent physical properties to be used for a food packaging material.

The present disclosure provides a bacterial nanocellulose transparent film having a barrier property formed as a transparent film having a multilayer structure of bacterial nanocellulose, wherein the bacterial nanocellulose is formed by electron beam irradiation and mechanical treatment on wet bacterial cellulose, and the bacterial nanocellulose includes nanocellulose consisting of cellulose nanofibers (CNF) aggregated with one or more cellulose nanofibrils. The cellulose nanofibers (CNF) include a carboxylate group, and the multilayer structure of the transparent film is formed by filtering and drying a dispersion of the bacterial nanocellulose, and the transparent film is alkali-treated and bleached to increase a mechanical property and a transparency, the mechanical property includes an Young's modulus, a tensile stress, or a tensile strain. The barrier property of the transparent film includes an oxygen barrier property, a moisture barrier property, or a UV barrier property.

Here, the bacterial cellulose, unlike woody cellulose, consists of only cellulose with almost no by-products such as hemicellulose and lignin.

The bacterial cellulose is a bottom-up process that is produced from glucose monomolecules into cellulose by bacteria.

Characteristics of the bacterial cellulose include a high degree of crystallization, a three-dimensional network structure, high mechanical properties, excellent moisture containing capacity, and the like. By using these properties, foods, cosmetics, wound dressings, artificial cartilage tissue, and the like have been used and studied.

The bacterial cellulose is also called nanocellulose. This is because the bacterial cellulose exists in the form of fibers with a width of 100 nm or less. However, the length and the width are not uniform.

Therefore, research on manufacturing uniform bacterial nanocellulose through mechanical treatment or chemical treatment has been conducted. In the case of bacterial cellulose having a uniform length, the length thereof is longer than that of nanocellulose prepared by the same treatment as other woody celluloses, and thus the bacterial cellulose has high mechanical property values.

In addition, it is possible to prepare uniform bacterial nanocellulose through electron beam irradiation and high-pressure homogenizer treatment on the bacterial cellulose. When the electron beam is irradiated, the degree of polymerization of cellulose may decrease, and oxidation may proceed to increase the carboxyl group content. Uniform and independent bacterial nanocellulose in the form of cellulose nanofibers may be obtained by irradiating a wet bacterial cellulose sheet with electron beam and mechanically treating the wet bacterial cellulose sheet.

In addition, the bacterial nanocellulose suspension prepared through electron beam treatment and mechanical treatment may be prepared into a film through vacuum filtration and oven drying. A transparent film is formed by improving transparency and physical properties through alkali treatment and bleaching on the film manufactured above to be used as a packaging material of a food packaging material or an electronic product packaging material.

It is possible to obtain mechanical properties, thermal stability, a UV barrier property, an oxygen barrier property, and moisture stability required for using the transparent film as the packaging material of the food packaging material or the electronic product packaging material.

In addition, the electron beam treatment on the wet bacterial cellulose sheet may obtain many advantages, such as a sterilization effect by eradicating microorganisms, cleavage of polymer chains, and modification through oxidation of the surface. In addition, the treatment method is simple. Due to these effects, it is possible to reduce treatment time and environmental problems when irradiating the electron beam during the process of preparing cellulose into nanocellulose. This technology may environmentally friendly replace a process which has been performed using chemical materials, such as acid treatment, alkali treatment, and blasting treatment, which are existing methods during the process of preparing nanocellulose.

In addition, the mechanical treatment may convert bacterial cellulose into bacterial nanocellulose.

In this case, the carboxylate group may be a carboxylate group at the sixth carbon position (C6) of the cellulose nanofibers (CNF).

Here, when the electron beam is treated on the wet bacterial cellulose sheet, a hydroxyl group at the sixth carbon position (C6) of the cellulose nanofibers (CNF) is entirely or partially converted into the carboxylate group.

In addition, the bacterial nanocellulose may include nanocellulose consisting of cellulose nanofibers (CNF) aggregated with one or more cellulose nanofibrils.

In addition, the shape of the cellulose nanofibers may be at least one shape selected from the group consisting of filament fibers, staple fibers, needle fibers, entangled fibers, and linear fibers.

Also, the bacterial nanocellulose transparent film may be a transparent film with a multilayer structure of bacterial nanocellulose, wherein

the bacterial nanocellulose is formed by electron beam irradiation and mechanical treatment on wet bacterial cellulose,

the cellulose nanofibers (CNF) have a carboxylate group, and

the cellulose nanofibers (CNF) have a diameter of 2 nm to 40 nm and a length of 500 nm to 20 μm.

In addition, a suspension of the bacterial nanocellulose may be re-dried to a powder through a spray dryer, the powder of the dried bacterial nanocellulose is redispersed from a powder to a dispersion.

In addition, the cellulose nanofibers (CNF) includes a crystalline portion and an amorphous portion constituting a crystal system, and the cellulose nanofibers (CNF) may have a diameter of 2 nm to 40 nm and a length of 500 nm to 20 μm.

In this case, the diameter of the cellulose nanofibers (CNF) may be 2.5 nm to 38 nm, more preferably 3 nm to 35 nm.

In addition, the length of the cellulose nanofibers (CNF) may be 520 nm to 18 μm, more preferably 550 nm to 15 μm.

In addition, the bacterial nanocellulose may exhibit a zeta potential of −50 mV to +50 mV.

Here, when the zeta potential of the bacterial nanocellulose has a value of −50 mV to +50 mV, the dispersion formed by the bacterial nanocellulose may be stable because the bacterial nanocellulose is uniformly dispersed well in a colloidal form.

At this time, the zeta potential of the bacterial nanocellulose may be preferably −40 mV to +40 mV, more preferably −30 mV to +30 mV.

In addition, the bacterial nanocellulose may have a light transmittance at 400 nm to 600 nm of 80% to 98%.

Here, the light transmittance of the nanocellulose at 400 nm to 600 nm may be preferably 82% to 95%, more preferably 83% to 93%.

In addition, the degree of polymerization (DP) of the bacterial nanocellulose may be 1 to 200.

In addition, the degree of polymerization of the bacterial nanocellulose may be decreased when the C—O—C bond content of the β-glycosidic bond is released.

Here, the degree of polymerization (DP) of the bacterial nanocellulose may be preferably 3 to 190, more preferably 5 to 180.

In addition, the bacterial nanocellulose may be manufactured as the transparent film having the multilayer structure.

In this case, the multilayer structure of the transparent film may be formed in a multilayer structure in which the bacterial nanocellulose fibers unified in the process of filtering and drying the bacterial nanocellulose dispersion are packed to be entangled with each other.

In addition, the transparency may be improved by alkali treatment and bleaching of the transparent film.

In addition, the transmittance at 400 nm to 600 nm of the bacterial nanocellulose transparent film may be 50% to 90%.

Here, the light transmittance at 400 nm to 600 nm of the bacterial nanocellulose transparent film may be preferably 52% to 88%, more preferably 55% to 85%.

In addition, in the oxygen barrier property of the bacterial nanocellulose transparent film, an oxygen transmission rate (OTR; cm³/m²·24 h·atm) at 23° C. and 0% relative humidity may be 2.0 to 110.

Herein, in the oxygen barrier property of the bacterial nanocellulose transparent film, the oxygen transmission rate (OTR; cm³/m²·24 h·atm) at 23° C. and 0% relative humidity may be preferably 2.1 to 108, more preferably 2.2 to 105.

As a moisture barrier property index, the swelling ratio before and after immersion in water of the bacterial nanocellulose transparent film may be 100% to 250%.

Here, the swelling ratio before and after immersion in water of the bacterial nanocellulose transparent film may be preferably 110% to 240%, more preferably 120% to 230%.

In addition, a UV-A (315 to 400 nm) transmittance of the bacterial nanocellulose transparent film used as a UV barrier property index may be 3% to 60%.

Here, the UV-A (315 to 400 nm) transmittance of the bacterial nanocellulose transparent film may be preferably 4% to 59%, more preferably 5% to 58%.

In addition, after irradiating artificial skin covered with the bacterial nanocellulose transparent film with a UV lamp of 365 nm used as a UV barrier property index for 72 hours, the thickness change of the epidermal layer of the artificial skin may be increased 1.05 times to 1.20 times.

Herein, after irradiating the artificial skin covered with the bacterial nanocellulose transparent film with the UV lamp of 365 nm for 72 hours, the thickness change of the epidermal layer of the artificial skin may be increased preferably 1.06 times to 1.19 times, more preferably 1.07 times to 1.18 times.

In addition, the mechanical property may be improved by alkali treatment and bleaching of the transparent film.

Here, the Young's modulus may be 6.6 GPa to 10.0 GPa, the tensile stress may be 80 MPa to 200 MPa, or the tensile strain may be 1% to 20%.

In addition, the Young's modulus as the mechanical property of the bacterial nanocellulose transparent film may be preferably 6.7 GPa to 9.9 GPa, more preferably 6.8 GPa to 9.8 GPa.

In addition, the tensile stress as the mechanical property of the bacterial nanocellulose transparent film may be preferably 82 MPa to 198 MPa, more preferably 85 MPa to 195 MPa.

In addition, the tensile strain as the mechanical property of the bacterial nanocellulose transparent film may be preferably 1.1% to 19.9%, more preferably 1.2% to 19.8%.

Bacterial Nanocellulose Consisting of Cellulose Nanofibers

The present disclosure provides a bacterial nanocellulose consisting of cellulose nanofibers, as bacterial nanocellulose consisting of cellulose nanofibers (CNF) aggregated with one or more cellulose nanofibrils, wherein the bacterial nanocellulose is formed by electron beam irradiation and mechanical treatment on wet bacterial cellulose, the cellulose nanofibers (CNF) include a carboxylate group, and the cellulose nanofibers (CNF) have a diameter of 2 nm to 40 nm and a length of 500 nm to 20 μm.

In this case, the cellulose nanofibers (CNF) include a crystalline portion and an amorphous portion constituting a crystal system, and the cellulose nanofibers (CNF) may have a diameter of 2 nm to 40 nm and a length of 500 nm to 20 μm.

In this case, the diameter of the cellulose nanofibers (CNF) may be 2.5 nm to 38 nm, more preferably 3 nm to 35 nm.

In addition, the length of the cellulose nanofibers (CNF) may be 520 nm to 18 μm, more preferably 550 nm to 15 μm.

In addition, a suspension of the bacterial nanocellulose may be re-dried to a powder through a spray dryer, the powder of the dried bacterial nanocellulose may be redispersed from a powder to a dispersion.

In addition, the bacterial nanocellulose may exhibit a zeta potential of −50 mV to +50 mV.

Here, when the zeta potential of the bacterial nanocellulose has a value of −50 mV to +50 mV, the dispersion formed by the bacterial nanocellulose may be stable because the bacterial nanocellulose is uniformly dispersed well in a colloidal form.

At this time, the zeta potential of the bacterial nanocellulose may be preferably −40 mV to +40 mV, more preferably −30 mV to +30 mV.

In addition, the bacterial nanocellulose may have a light transmittance at 400 nm to 600 nm of 80% to 98%.

Here, the light transmittance of the nanocellulose at 400 nm to 600 nm may be preferably 82% to 95%, more preferably 83% to 93%.

In addition, the degree of polymerization (DP) of the bacterial nanocellulose may be 1 to 200.

At this time, the degree of polymerization of the bacterial nanocellulose may be increased when a C—O—C bond content of a β-glycosidic bond is increased.

Here, the degree of polymerization (DP) of the bacterial nanocellulose may be preferably 3 to 190, more preferably 5 to 180.

Here, when the electron beam is treated on the wet bacterial cellulose sheet, a hydroxyl group at the sixth carbon position (C6) of the cellulose nanofibers (CNF) may be entirely or partially converted into the carboxylate group.

In addition, the bacterial nanocellulose may include nanocellulose consisting of cellulose nanofibers (CNF) aggregated with one or more cellulose nanofibrils.

In addition, the shape of the cellulose nanofibers may be at least one shape selected from the group consisting of filament fibers, staple fibers, needle fibers, entangled fibers, and linear fibers.

Manufacturing Method of Bacterial Nanocellulose Transparent Film

In addition, since the manufacturing method of the bacterial nanocellulose transparent film of the present disclosure is a process of performing a film process with a chemical material that is not harmful to a bacterial nanocellulose dispersion, the method is eco-friendly and the process is relatively simple and economical.

The present disclosure provides a manufacturing method of a bacterial nanocellulose transparent film comprising: (1) preparing a bacterial nanocellulose dispersion consisting of cellulose fibers (CNF) having a carboxylate group by irradiating electron beam on wet bacterial cellulose; and (2) forming a bacterial nanocellulose transparent film by vacuum filtration and oven drying of the bacterial nanocellulose dispersion.

Here, the preparing of the bacterial nanocellulose dispersion in step (1) may comprise (a) separating the wet bacterial cellulose into cellulose fibers having a carboxylate group by irradiating the electron beam; (b) alkalizing the cellulose fibers having the carboxylate group by adding an alkali compound; (c) preparing cellulose nanofibers having a carboxylate group by separating the alkalized cellulose fibers having the carboxylate group with a high-pressure machine device; and (d) preparing a nanocellulose dispersion consisting of cellulose nanofibers (CNF) having a carboxylate group by adding carbon dioxide (CO₂) to the cellulose nanofibers having the carboxylate group, neutralizing and centrifuging.

In addition, the forming of the bacterial nanocellulose transparent film in step (2) may further comprise oven-drying the bacterial nanocellulose dispersion, alkali-treating by adding an alkali compound, and then bleaching.

In addition, the beam intensity of the electron beam may be 200 kGy to 3000 kGy.

In this case, the beam intensity of the electron beam may be preferably 300 kGy to 2000 kGy, more preferably 500 kGy to 1500 kGy.

Here, the electron beam forms a radical, and the radical has the effect of cutting a glycosidic chain or oxidizing a hydroxyl group of cellulose.

In addition, more radicals are generated when the electron beam is irradiated to a material in a wet state than a material in a dry state.

Accordingly, bacterial cellulose in a wet state may be easily oxidized when irradiated with electron beam than bacterial cellulose in a dry state, so that the content of a carboxylate functional group may be increased.

That is, when the electron beam is irradiated to the wet bacterial cellulose, the glycosidic chain may be cut less or many hydroxyl groups of the cellulose may be oxidized to generate a lot of carboxyl groups.

In addition, the high-pressure machine device may include a high-pressure homogenizer, an ultra-turrax, an ultrasonicator, or a grinder.

In addition, the alkali compound may be at least one selected from the group consisting of sodium hydroxide (NaOH), potassium hydroxide (KOH), magnesium hydroxide (Mg(OH)₂), and calcium hydroxide (Ca(OH)₂).

In addition, the bleaching may be performed using a bleaching agent of NaClO, NaClO₂, or H₂O₂.

In addition, the transparency may be increased by alkali treatment and bleaching of the transparent film.

Also, the manufacturing method of the bacterial nanocellulose transparent film may be a manufacturing method of a bacterial nanocellulose transparent film with a multilayer structure of the bacterial nanocellulose after a preparation method of bacterial nanocellulose consisting of cellulose nanofibers, the preparation method of bacterial nanocellulose consisting of cellulose nanofibers comprising:

(1) separating bacterial cellulose fibers (BCF) having a carboxylate group from the bacterial cellulose by irradiating electron beam to wet bacterial cellulose;

(2) alkalizing the bacterial cellulose fibers having the carboxylate group by adding an alkali compound;

(3) preparing bacterial cellulose nanofibers having a carboxylate group by separating the alkalized bacterial cellulose fibers (BCF) having the carboxylate group with a high-pressure machine device;

(4) preparing a bacterial nanocellulose dispersion consisting of bacterial cellulose nanofibers (BCNF) having a carboxylate group by adding carbon dioxide (CO₂) to the bacterial cellulose nanofibers having the carboxylate group, neutralizing and centrifuging; and

(5) preparing bacterial nanocellulose consisting of the bacterial cellulose nanofibers (BCNF) having the carboxylate group by drying the bacterial nanocellulose dispersion.

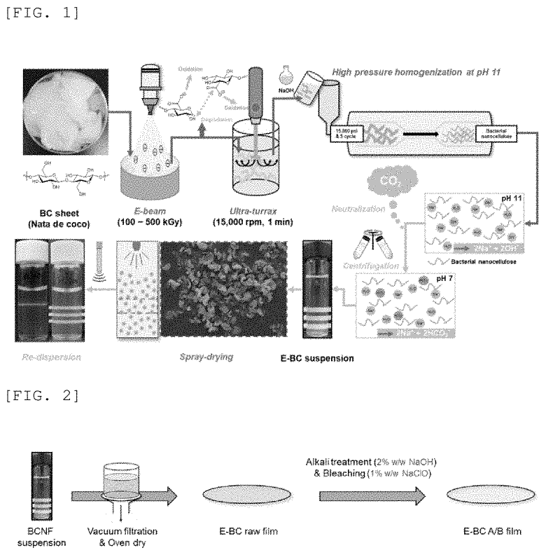

FIG. 1 is a schematic diagram of a process of preparing bacterial nanocellulose consisting of cellulose nanofibers by irradiating bacterial cellulose with electron beam and then separating the bacterial cellulose by a high-pressure mechanical device.

Referring to FIG. 1, it is possible to break the C—O—C bond of the β-glycosidic bond of the bacterial cellulose by irradiating the electron beam on the wet bacterial cellulose and to prepare cellulose fibers by converting the hydroxyl functional group of the sixth carbon (C6) of the bacterial cellulose into a carboxylate functional group.

Thereafter, the cellulose fibers may be washed with water to remove a water-soluble material.

Then, an alkali compound is added to increase the pH to 11 and prepare alkalized cellulose fibers, and then the alkalized cellulose fibers were separated into nano-sized pieces using a high-pressure homogenizer (HPH) to prepare bacterial nanocellulose consisting of cellulose nanofibers (CNF).

After the high-pressure homogenizer treatment, the pH of the dispersion may be lowered to 7 by adding carbon dioxide (CO₂). When carbon dioxide (CO₂) is added to water, carbonic acid is produced, which has the effect of lowering the pH.

Thereafter, the bacterial nanocellulose dispersion having the lowered pH may be centrifuged to obtain bacterial nanocellulose as a supernatant.

Here, the redispersibility of the bacterial nanocellulose may be confirmed by spray-drying and then redispersing the obtained bacterial nanocellulose.

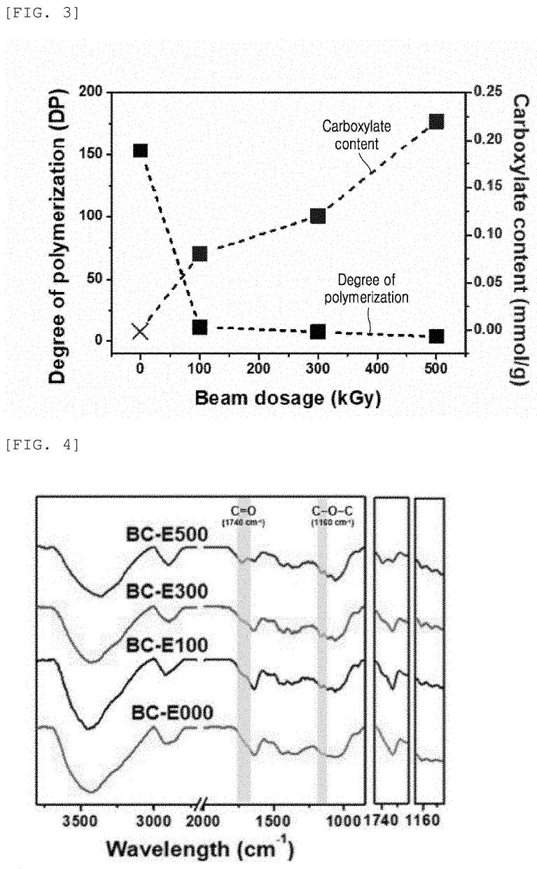

FIG. 2 is a schematic diagram of a process of manufacturing a bacterial nanocellulose transparent film with high light transmittance by alkali-treating and bleaching a bacterial nanocellulose dispersion.

Referring to FIG. 2, a bacterial nanocellulose transparent film (E-BC A/B film) with improved transparency may be manufactured by preparing a bacterial nanocellulose raw film (E-BC raw film) by vacuum filtration and oven drying of a bacterial nanocellulose suspension (BCNF suspension), alkali-treating the prepared E-BC raw film with an aqueous NaOH solution and then bleaching the E-BC raw film with an aqueous NaClO solution.

Preparation Method of Bacterial Nanocellulose Consisting of Cellulose Nanofibers

The present disclosure provides a preparation method of bacterial nanocellulose consisting of cellulose nanofibers comprising: (1) separating bacterial cellulose fibers (BCF) having a carboxylate group from the bacterial cellulose by irradiating electron beam to wet bacterial cellulose; (2) alkalizing the bacterial cellulose fibers having the carboxylate group by adding an alkali compound; (3) preparing bacterial cellulose nanofibers having a carboxylate group by separating the alkalized bacterial cellulose fibers (BCF) having the carboxylate group with a high-pressure machine device; (4) preparing a bacterial nanocellulose dispersion consisting of bacterial cellulose nanofibers (BCNF) having a carboxylate group by adding carbon dioxide (CO₂) to the bacterial cellulose nanofibers having the carboxylate group, neutralizing and centrifuging; and (5) preparing bacterial nanocellulose consisting of the bacterial cellulose nanofibers (BCNF) having the carboxylate group by drying the bacterial nanocellulose dispersion.

In addition, the beam intensity of the electron beam may be 200 kGy to 3000 kGy.

In this case, the beam intensity of the electron beam may be preferably 300 kGy to 2000 kGy, more preferably 500 kGy to 1500 kGy.

Here, the electron beam forms a radical, and the radical has the effect of cutting a glycosidic chain or oxidizing a hydroxyl group of cellulose.

In addition, more radicals are generated when the electron beam is irradiated to a material in a wet state than a material in a dry state.

Accordingly, bacterial cellulose in a wet state may be easily oxidized when irradiated with electron beam than bacterial cellulose in a dry state, so that the content of a carboxylate functional group may be increased.

That is, when the electron beam is irradiated to the wet bacterial cellulose, the glycosidic chain may be cut less or many hydroxyl groups of the cellulose may be oxidized to generate a lot of carboxyl groups.

In addition, the high-pressure machine device may include a high-pressure homogenizer, an ultra-turrax, an ultrasonicator, or a grinder.

In addition, the alkali compound may be at least one selected from the group consisting of sodium hydroxide (NaOH), potassium hydroxide (KOH), magnesium hydroxide (Mg(OH)₂), and calcium hydroxide (Ca(OH)₂).

Packaging Material Using Bacterial Nanocellulose Transparent Film

Since the bacterial nanocellulose transparent film may be variously applied to packaging materials including a food packaging material or an electronic product packaging material, the present disclosure has an advantage that the scope of application is various.

The present disclosure provides a packaging material including a food packaging material or an electronic product packaging material using a bacterial nanocellulose transparent film.

The bacterial nanocellulose suspension prepared through electron beam treatment and mechanical treatment may be manufactured into a film through vacuum filtration treatment and oven drying. A transparent film is formed by improving transparency and physical properties through alkali treatment and bleaching on the film manufactured above to be used as a packaging material of a food packaging material or an electronic product packaging material.

It is possible to obtain mechanical properties, thermal stability, a UV barrier property, an oxygen barrier property, and moisture stability required for using the transparent film as the packaging material of the food packaging material or the electronic product packaging material.

Hereinafter, the present disclosure will be described in more detail with reference to Examples. However, the following Examples are for explaining the present disclosure in more detail, and the scope of the present disclosure is not limited by the following Examples. The following Examples can be appropriately modified and changed by those skilled in the art within the scope of the present disclosure.

### EXAMPLES

### <Example 1> Preparation of Bacterial Nanocellulose Consisting of Cellulose Nanofibers

Electron beam irradiation on bacterial cellulose A bacterial cellulose sheet (solid content 4%, Nata de coco, Cellulose, citric acid, sugar, coconut water etc. TMB Co. Ltd.) was irradiated with electron beam using MB10-8/635 in Seoul Radiology Services Co., Ltd. (Chungbuk, Korea). All samples were irradiated with electron beam of 100, 300, and 500 kGy. After electron beam irradiation, all samples were washed through stirring and filtration using ultrapure water 100 times greater than the solid content, and stored in a zipper bag at 4° C.

Preparation of Uniform Bacterial Nanocellulose Through Mechanical Treatment

For dissociation of electron-beam irradiated bacterial cellulose (E-BC), a solid concentration was made to 0.5% w/w in ultrapure water, and treated with a small homogenizer (T 25 digital ultra-turrax, IKA) at 15,000 rpm for 1 minute. Then, after dilution to 0.3% w/w, the pH was adjusted to 11 using a 0.5 M NaOH solution to make an alkaline condition.

An E-BC suspension in the alkaline condition was treated 5 times at 15,000 psi with a high pressure homogenizer (HPH) (Mini DeBEE, BEE international, MA), and the prepared sample was injected with CO₂ to be lowered to pH 7, which was a neutral condition. Subsequently, a supernatant was recovered after treatment at 10,000 rpm for 15 minutes through a high-speed centrifuge (LaboGene 2236R, Gyrozen) to prepare a uniformly nanosized transparent bacterial nanocellulose (BC-NC) suspension.

Spray-Drying and Redispersion

The bacterial nanocellulose (BC-NC) suspension was re-dried to a powder sample through a spray dryer (Mini Spray Dryer, B-290, BÜCHI, Switzerland).

The dried BC-NC powder was analyzed by scanning electron microscopy (SEM. MIRA 3, Tescan Czech Republic). In order to examine the redispersibility, the powdered BC-NC sample was put in ultrapure water to prepare a 0.2% w/w mixed solution, and treated for 1 minute at 20% amplitude in a sonicator.

As a result of redispersion, it was easily redispersed from the powder to the dispersion.

### <Example 2> Manufacture of Bacterial Nanocellulose Film

Manufacture of Bacterial Nanocellulose Film (BC-NC-E Film) Through Vacuum Filtration and Oven Drying

A transparent film (E-BC film) was manufactured using the BC-NC prepared in Example 1 through electron beam irradiation (100, 300, and 500 kGy) and mechanical treatment (small homogenizer and high pressure homogenizer) on wet bacterial cellulose. The film manufacturing method used a method of simultaneously carry out vacuum filtration and oven drying. The 0.3% w/w E-BC suspension (solid content of 0.5 g) was vacuum filtered and oven dried at 35° C. for 6 to 8 hours to manufacture a bacterial nanocellulose film (BC-NC-E film).

Alkali Treatment and Bleaching

In order to improve the transparency of the manufactured film and to remove materials other than cellulose, alkali treatment was performed using a NaOH solution. The dried BC-NC-E film was immersed in a 2% w/w NaOH solution for 30 minutes, and washed with ultrapure water for 5 minutes.

Thereafter, vacuum filtration and oven drying (35° C.) were simultaneously performed to manufacture an alkali-treated film (E-BC-A).

In addition, bleaching was performed to improve the transparency of the bacterial cellulose film browned by electron beam irradiation and to remove by-products that were not removed in the alkali treatment. The film E-BC-A, which had been subjected to alkali treatment, was immersed in a 1% w/w NaClO solution for 30 minutes, and then treated by washing with ultrapure water for 5 minutes. Thereafter, vacuum filtration and oven drying (35° C.) were simultaneously performed to manufacture an alkali-treated and bleached film (E-BC-A/B).

### <Comparative Example> Preparation of Control TOCN Film

In order to set a control for the BC-NC-E film, a film was prepared using TEMPO oxidized cellulose nanofibers (TOCN) 0.3% w/w. The TOCN film was prepared through vacuum filtration and oven drying, as the same method as the BC-NC-E film.

### Analysis Example

### <Analysis Example 1> Structural Analysis

In order to confirm structural characteristics of bacterial cellulose, the bacterial cellulose was measured in the range of 4000 to 650 cm⁻¹ by Fourier transform Infrared spectroscopy (FTIR, Cary 630, Agilent, USA). Sample pretreatment was performed by grinding potassium bromide (KBr) and freeze-dried bacterial cellulose with a mortar to be prepared in the form of a plate.

### <Analysis Example 2> Analysis of Degree of Polymerization

The intrinsic viscosity [η] of bacterial cellulose was measured using a Cannon-Fenske capillary viscometer, and converted into a degree of polymerization. 0.25 g of a freeze-dried bacterial cellulose sample was added in 50 ml of a 0.5 M cupriethylenediamine (CED) solution and dissolved in a 25° C. incubator for 6 hours, and then the viscosity was measured using a capillary viscometer. The degree of polymerization (DPv) was converted and calculated to intrinsic viscosity [η].

The intrinsic viscosity [η] was confirmed as [η]×c (c, concentration, g/100 mL) by referring to ASTM D4243-99. The degree of polymerization was measured using the formula DP_{w}=[η]×190.

### <Analysis Example 3> Measurement of Carboxyl Group Content

The carboxyl group content was measured to determine the degree of oxidation. The carboxyl group content may be measured by an electric conductivity titration method using a high end titrator (888 Tirando, Metrohm AG, Switzerland). 0.1 g of the freeze-dried sample was added in 60 mL of ultrapure water and sufficiently dissociated through a stirrer, and then added with 0.1 M HCl to lower the pH to 3.0 or less. Thereafter, a 0.04 M NaOH solution was added at a rate of 0.2 mL min⁻¹ and titrated to pH 11.

### <Analysis Example 4> Shape Analysis

After mechanical treatment, the prepared BC-NC suspension (0.005% w/w suspension) was placed on a carbon coated copper grid (CF 200-Cu, EMS), and then coated and stained with uranyl acetate (0.2% w/w solution) to measure a transmission electron microscope (TEM), and as a result, the shape thereof was confirmed.

### <Analysis Example 5> Thermal Analysis

To determine thermal stability, TGA and DTG were measured. The thermal stability was analyzed using a TA Q500 thermogravimetric analyzer. The freeze-dried suspension sample and 5 to 10 mg of the manufactured BC film were measured under a nitrogen condition at a temperature rising rate of 10° C. min⁻¹ and a measurement temperature was measured from 35° C. to 600° C.

### <Analysis Example 6> Analysis of Crystallization Index

To determine the crystallinity of bacterial cellulose, the bacterial cellulose was freeze-dried, and a BC film was dried at 35° C. for 24 hours and then the crystallinity was measured using X-ray diffraction equipment. A Rigaku Ultima IV X-Ray diffractor was used as the equipment, and the crystallinity was measured using Cu radiation (λ=0.154 nm) in the range of 2 θ=5° to 40° at 40 KV and 40 mA.

### <Analysis Example 7> Analysis of Surface Charge and Transparency

A surface charge of the BC suspension at a concentration of 0.1% w/w was measured using a Laser-Propper-Velocimeter (Zetasizer Nano ZS series, Malvern Instruments Ltd, UK) of a ζ-potential in a pH 7 condition.

The transparency of the suspension of 0.1% w/w concentration was measured at 400 nm to 600 nm using a spectrometer (UV 1650 PC, Shimadzu, Japan).

### <Analysis Example 8> Analysis of Transparency and Absorbance

In order to confirm the improvement of the transparency of the prepared BC suspension and the transparency after alkali treatment and bleaching of the prepared bacterial cellulose film, with respect to the suspension 0.1% w/w and the BC films E-BC, E-BC-A, and E-BC-A/B, the transmittance at 400 nm to 600 nm was measured using a spectrometer (UV 1650 PC, Shimadzu, Japan).

In addition, in order to confirm whether by-products (protein, and nucleic acid) of bacterial cellulose were removed, the absorbance was measured at 200 nm to 400 nm using a spectrometer (UV 1650 PC, Shimadzu, Japan).

### <Analysis Example 9> Measurement of Tensile Strength

In order to examine the mechanical properties of the manufactured film, a tensile strength test was performed. A tensile strength test sample was prepared by cutting the film into a size of 2 mm in width and 30 mm in length. The measurement conditions were set to a gauge length of 10 mm and a tensile speed of 10 mm min⁻¹, and a 250 N load cell was weighed and measured. The tensile strength was measured total 10 times or more.

### <Analysis Example 10> Measurement of Oxygen Permeability

Oxygen permeability was measured by analysis requested to the Korea Polymer Testing & Research Institute, Korea Laboratory Accreditation Scheme, and was measured according to ASTM D 3985. A film was prepared in a size of 20×20 mm and the transmittance thereof was measured by OX-TRAN Model 701. The measurement was performed at a test temperature of (23±2°) C. and in a measurement range of 0.01 to 10,000 (cm³/m²·24 hr·atm).

### <Analysis Example 11> Measurement of UV Barrier Property

Artificial pig skin (FCM) was purchased to measure a UV barrier property of the manufactured film. The film was covered on the artificial pig skin and irradiated with ultraviolet light in a 365 nm wavelength band for 72 hours through an ultraviolet lamp (Vilber Lourmat. BP 66—torcy Z, France).

The UV-treated artificial pig skin was stained with hematoxylin & eosin staining (H&E staining), and thickness changes of the epidermal layer were measured at five points total five times through an optical microscope (i-solution).

### <Analysis Example 12> Measurement of Moisture Resistance

A moisture resistance experiment was conducted to determine the stability of a film in immersion conditions. The prepared bacterial cellulose film was prepared with a size of 20×20 mm. These films were immersed in 60 mL of ultrapure water for 7 days. Thereafter, the films were stored in a constant temperature and humidity room for 1 hour to measure the weight. A swelling ratio was calculated using a weight (g) before immersion and a weight (g) after immersion as shown in Equation 1 below.

$$Swelling ratio ( \% ) = \frac{\begin{matrix}weight ( g ) of film after immersion - \\ weight ( g ) of film before immersion\end{matrix}}{weight ( g ) of film before immersion} \times 100 ( \% ) \qquad [ Equation 1 ]$$

### Experimental Examples

### <Experimental Example 1> Physical Property Data of E-Beam Irradiated Bacterial Cellulose

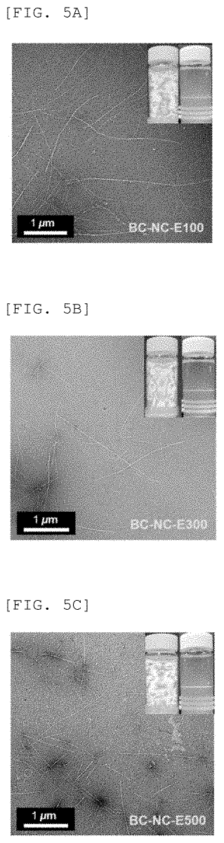

FIG. 3 is a graph showing a correlation between a carboxyl group content and a degree of polymerization when wet bacterial cellulose is irradiated with electron beam.

Referring to FIG. 3, it was confirmed that when electron beam of 0 to 500 kGy was irradiated to wet bacterial cellulose, a degree of polymerization (DP) decreased from 153.5 to 3.8.

In addition, in order to examine an oxidation effect, a change in carboxyl group content was determined using a conductivity titration method.

Referring to FIG. 3, the carboxyl group content of bacterial cellulose irradiated at 100, 300, and 500 kGy was 0.08 to 0.22 mmol g⁻¹, and confirmed to have a tendency to increase in proportion to an irradiation amount.

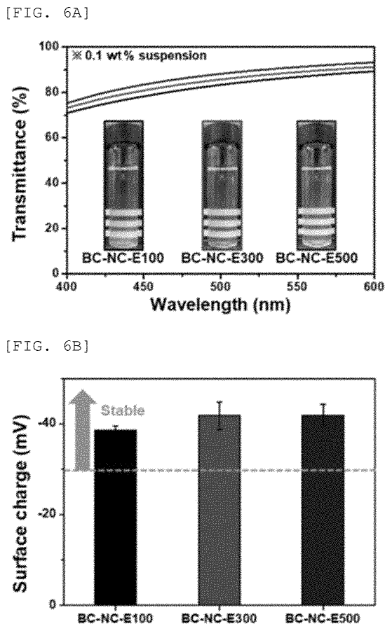

FIG. 4 is FT-IR data of a bacterial cellulose raw material and bacterial cellulose irradiated with electron beam according to Example 1.

Referring to FIG. 4, it was confirmed that the intensity of 1160 cm⁻¹ decreased during the electron beam treatment. This was because C—O—C stretching was reduced by chain cleavage.

In addition, it was confirmed that a new band appeared at 1740 cm⁻¹, and the intensity increased as the electron beam intensity increased. This was a carbonyl peak of carboxylic acid.

Through this, it was confirmed that oxidation occurred as the electron beam intensity increased. The tendency was consistent with the results of the degree of polymerization and the carboxyl group measurement.

The measurement results were shown in Table 1.1.

Table 1.1 showed physical property data after wet bacterial cellulose was irradiated with electron beam.

TABLE 1.1
Characterization data of wet bacterial cellulose disassociated
by electron beam irradiation at 100, 300, 500 kGy.

| | | | Carboxylate | | | | |
|---|---|---|---|---|---|---|---|
| | Radiation | Dissociation | content | | CrI | T_{d onset} | T_{d max} |
| | dosage (kGy)^{a} | yield (%)^{b} | (mmol g⁻¹)^{c} | DP_{w}^{d} | (%)^{e} | (° C.)^{f} | (° C.)^{g} |
| BC-E000 | 0 | 98.5 | N/A | 153.5 | 91.7 | 306 | 363 |
| BC-E100 | 100 | 96.5 | 0.08 | 11.4 | 87.7 | 281 | 368 |
| BC-E300 | 300 | 94.4 | 0.12 | 7.5 | 87.9 | 270 | 360 |
| BC-E500 | 500 | 88.4 | 0.22 | 3.8 | 86.4 | 257 | 357 |

^{a}All the bacterial cellulose sample were treated by electron beam irradiation at 100, 300, 500 kGy.
^{b}Calculated from the oven dried mass of the bacterial cellulose obtained thorough E-beam vs their original masses.
^{c}Evaluation of carboxylate content on the bacterial cellulose using conductometric titration.
^{d}Calculated based on relationship with intrinsic viscosity and degree of polymerization. Intrinsic viscosity of bacterial cellulose was calculated from the viscosity ratio of bacterial cellulose and cupriethylenediamine (CED) solution using Martin’s equation.
^{e}The crystallinity index (CrI) of the bacterial cellulose was calculated from XRD data using equation reported by Segal et al.: CrI (%) = [(I₀₀₂ − Iₐₘ)/I₀₀₂] × 100, where I₀₀₂ is the peak intensity of the main crystalline plane (002) lattice diffraction at 2 θ = 22-23° and Iₐₘ is the diffraction intensity of the amorphous fraction at 2 θ = 18-19°
^{f}5% weight loss determined by TGA after 100° C.
^{g}The temperature of the maximum degradation rate using DTG.

### <Experimental Example 2> Physical Property Data of Bacterial Nanocellulose after Mechanical Treatment

The bacterial cellulose (E-BC) of Example 1 was treated with a small homogenizer and a high pressure homogenizer. At this time, in order to further improve a treatment effect of the high-pressure homogenizer, the pH was adjusted to 11 using a 0.5 M NaOH solution. In the case of cellulose, swelling occurred under basic conditions.

In addition, a carboxyl group at carbon 6 was changed from a COOH form to a COO⁻Na⁺ form by NaOH to generate an electrostatic repulsion. Through the swelling and the electrostatic repulsion, the shear stress generated between the celluloses during the mechanical treatment was applied more effectively.

FIG. 5A shows TEM images of bacterial nanocellulose irradiated with 100 kGy electron beam, FIG. 5B shows TEM images of bacterial nanocellulose irradiated with 300 kGy electron beam, and FIG. 5C shows TEM images of bacterial nanocellulose irradiated with 500 kGy electron beam, which are all manufactured according to Example 1.

The length and width of the prepared bacterial nanocellulose (BC-NC) could be measured through TEM images. The lengths and widths were measured for 100 samples or more for each condition and an average value thereof was measured.

Table 1.2 showed physical property data of the bacterial nanocellulose.

TABLE 1.2
Characterization data for bacterial nanocellulose originated
from disassociated bacterial cellulose sheet.

| | Yield | Length | Width | Transmittance | Charge | CrI | T_{d onset} | T_{d max} |
|---|---|---|---|---|---|---|---|---|
| BC | (%)^{a} | (μm)^{b} | (nm)^{b} | (%)^{c} | (mV)^{d} | (%)^{e} | (° C.)^{f} | (° C.)^{g} |
| BC-NC-E100 | 85 | 2.9 ± 0.4 | 9.9 ± 1.2 | 89 | −38.6 ± 0.9 | 88 | 189 | 224, 301 |
| BC-NC-E300 | 90 | 2.2 ± 0.4 | 7.9 ± 1.0 | 91 | −41.8 ± 3.0 | 88 | 191 | 233, 309 |
| BC-NC-E500 | 85 | 1.8 ± 0.3 | 6.5 ± 0.9 | 93 | −41.9 ± 2.4 | 86 | 193 | 237, 313 |

^{a}Calculated from oven dried mass of the homogeneous nano-sized bacterial cellulose obtained through ultra-turrax and high pressure homogenization the dissociated bacterial cellulose treated by electron beam irradiation at 100. 300, 500 kGy vs the original masses.
^{b}Evaluated with TEM. All values were reported the average at least one hundred samples.
^{c}The value at a wavelength was at 600 nm using UV-Vis spectrometer.
^{d}Evaluated the surface charge of bacterial nanocellulose suspension (0.1% w/w) using Laser dropper velocimetry at pH 7 at least 3 times.
^{e}The crystallinity index (CrI) of the bacterial cellulose was calculated from XRD data using equation reported by Segal et al.: CrI (%) = [(I₀₀₂ − Iₐₘ)/I₀₀₂] × 100. where I₀₀₂ is the peak intensity of the main crystalline plane (002) lattice diffraction at 2 θ = 22-23° and Iₐₘ is the diffraction intensity of the amorphous fraction at 2 θ = 18-19°
^{f}5% weight loss determined by TGA after 100° C.
^{g}The temperature of the maximum degradation rate using DTG.

Referring to FIG. 5A˜FIG. 5C and Table 1.2, as the irradiation amount of the electron beam increased, the average length decreased from 2.9 μm to 1.8 μm, and the thickness decreased from 9.9 nm to 6.5 nm. Although the length and the thickness were decreased, it was confirmed that the values thereof were uniform for each condition.

In addition, a Tyndall effect and Chiral nematic were clearly observed, and as a result, it was confirmed that the bacterial nanocellulose was stably well dispersed.

When the bacterial cellulose was treated with a small homogenizer and a high pressure homogenizer after electron beam treatment (100, 300, and 500 kGy), as shown in Table 1.2, a yield of about 85 to 90% may be obtained.

Considering that the yield was about 33 to 67% in a previous study of preparing woody cellulose into nanocellulose using electron beam, when the electron beam was irradiated to the bacterial cellulose, it was confirmed that the bacterial nanocellulose had higher yield than nanocellulose prepared from woody cellulose.

FIG. 6A shows a UV-Vis transmittance graph of a bacterial nanocellulose dispersion and FIG. 6B shows a Zeta potential graph of a bacterial nanocellulose dispersion according to Example 1.

Referring to FIG. 6A and Table 1.2, as a result of measuring transmittance in a wavelength band of 400 to 600 nm at 0.1% w/w concentration of a dispersion to measure the degree of transparency, a 600 nm wavelength value was 91 to 94% and as a result, the BC-NC dispersion was transparent.

Referring to FIG. 6B and Table 1.2, as a result of measuring the surface charge, it could be seen that the BC-NC suspension had the surface charges of −38.6, −41.8, and −41.9 mV which were 30 mV or higher of an absolute value of the surface charge, which was a criterion that the BC-NC suspension was stably dispersed.

The reason for this result was that oxidation occurred by the electron beam treatment and a carboxyl group was introduced.

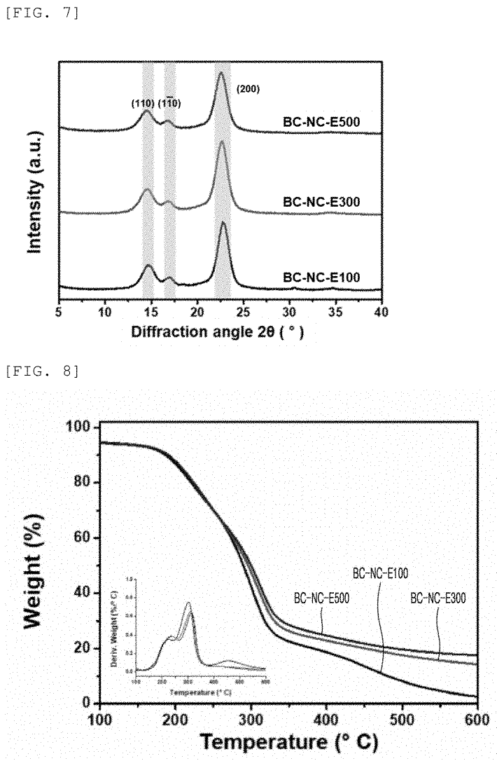

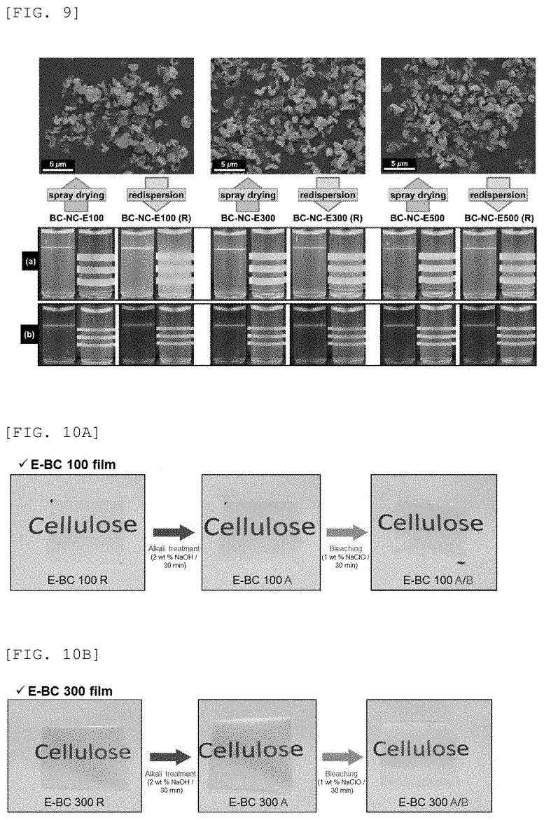

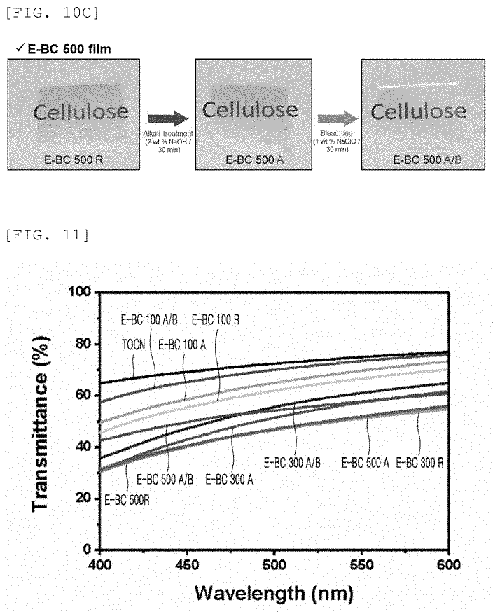

FIG. 7 shows an XRD graph of freeze-dried bacterial nanocellulose powder according to Example 1.

XRD analysis was performed to confirm a crystallization index (CrI). As a result of the measurement, crystal peaks of a cellulose I structure were measured. Through this, it was confirmed that an essential crystal structure of cellulose was maintained even after the electron beam treatment. The crystallization index capable of affecting mechanical properties, thermal stability, and an oxygen barrier property was calculated using a Segal equation.

Referring to FIG. 7 and Table 1.2, it was confirmed that the crystallization index was 86 to 88%, and the result was obtained that there was no large negative effect on the crystallization index even if the mechanical treatment was performed after the electron beam treatment.

### <Experimental Example 3> Thermal Behavior Data

In order to determine how electron beam irradiation and mechanical treatment affected thermal stability, TGA and DTG of the bacterial nanocellulose prepared in Example 1 were confirmed. All BC-NC samples decreased in weight due to evaporation of moisture up to around 100° C.

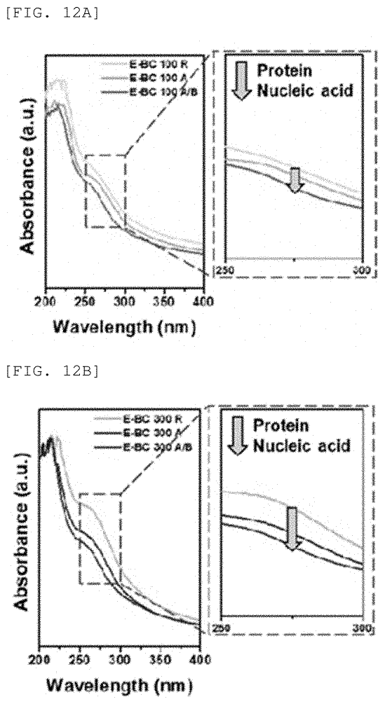

FIG. 8 shows a TGA graph of bacterial nanocellulose subjected to electron beam irradiation and mechanical treatment according to Example 1.

Referring to FIG. 8, it was confirmed that a Td onset of BC-NC of Example 1 was 189 to 193° C. in a TGA result.

As compared with a value of pure BC before mechanical treatment, it was confirmed that this value was largely decreased. It was considered that the reason was that damage occurred in a crystalline region of cellulose by shear stress in BC during mechanical treatment. Td max values were shown in two vicinities of 224 to 237° C. and 301 to 313° C. The reason was that oxidation occurred by electron beam irradiation. Compared with the value of BC before mechanical treatment, it can be seen that the result was significantly reduced. It was considered that the reason was that the specific surface area was widened with the introduction of carboxyl groups and nanonization.

### <Experimental Example 4> Results of Drying and Redispersion of BC-NC Dispersion

Nanocellulose was mostly prepared and used in a state dispersed in water. However, considering the transportation cost, transportation costs may be reduced when transporting in powder form after drying rather than transporting in a suspension state. A representative drying method included oven drying, spray drying, and freeze drying. Among these methods, spray drying can be treated in a large capacity, and the sample can be dried by controlling the sample to a micro unit. In order to determine whether the prepared bacterial cellulose was redispersed, suspensions BC-NC-E100, BC-NC-E300, and BC-NC-E500 were dried by spray drying. As a result of observing the shape of the dried sample through SEM, it was confirmed that the sample had a uniform shape. In addition, in order to confirm the redispersion, the sample was redispersed at a concentration of 0.2% w/w in ultrapure water through ultrasonication. As a result, it was confirmed that BC-NC-E100 treated for 1 minute was more opaque than the redispersion suspensions of BC-NC-E300 and BC-NC-E500. However, when the ultrasonic treatment time was increased to 2 minutes or more, it was confirmed that the BCNC-E100 was also transparently redispersed. The reason why the prepared bacterial cellulose can be redispersed is just a carboxyl group. When oxidized by electron beam, a hydroxyl group of carbon 6 became a carboxyl group, and NaOH was added to convert H⁺ to Na⁺, resulting in electrostatic repulsion. When dried by this electrostatic repulsion, hydrogen bonds between celluloses were disturbed, and agglomeration was reduced, and thus, BC-NC powder that can be redispersed again could be prepared by physical treatment.

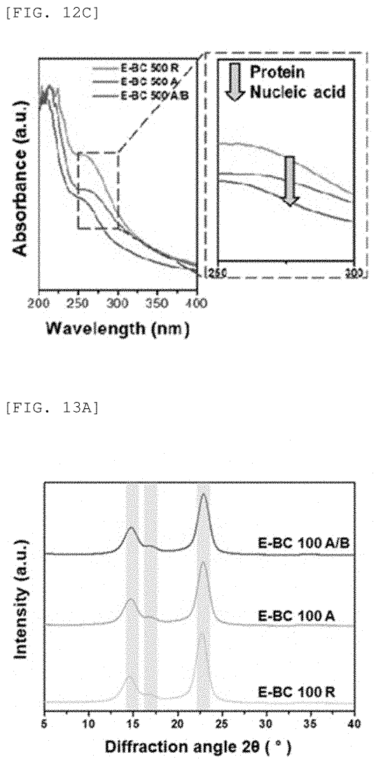

FIG. 9 shows an SEM image of bacterial nanocellulose according to Example 1 and redispersion experiment result images after (a) 1 minute ultrasonication and (b) 3 minute ultrasonication.

Referring to FIG. 9, as a result of confirming the yield after ultrasonication of 1 minute, it was confirmed that BC-NC-E100 had a low yield of 40%, but BC-NC-E300 and BC-NC-E500 had 96 to 98% of a high redispersion yield.

It was considered that the reason for this difference was that BC-NC-E100 was also oxidized by electron beam treatment so that a carboxyl group was introduced, but compared to an average length of 2.9 μm of BC-NC-E100, the electrostatic repulsion of the carboxyl group was insufficient.

### <Experimental Example 5> Physical Property Data of Bacterial Nanocellulose Film

A typical method for manufacturing a film using nanocellulose included a casting method and a vacuum filtration method. In the present disclosure, a vacuum filtration method was used to manufacture BC-NC-E as a film.

FIG. 10A shows images of a film (E-BC-100 R), a film (E-BC-100 A), and a film (E-BC-100 A/B), FIG. 10B shows images of a film (E-BC-300 R), a film (E-BC-300 A), and a film (E-BC-300 A/B), and FIG. 10C shows images of a film (E-BC-500 R), a film (E-BC-500 A), and a film (E-BC-500 A/B), which are all manufactured according to Example 2.

Referring to FIG. 10A, the film (E-BC-100 R) was manufactured by simultaneously performing vacuum filtration and oven drying of the BC-NC-E dispersion.

When vacuum filtration and oven drying were performed at the same time, there are advantages that the time required for manufacturing the film may be reduced and physical properties increased while applying a pressure during drying.

In order to improve the transparency and physical properties of the film (E-BC-100 R) manufactured through vacuum filtration and oven drying, the film (E-BC-100 A) was manufactured by alkali treatment (2% w/w NaOH solution for 30 min).

Also, in order to improve the transparency and physical properties of the film (E-BC-100 R) manufactured through vacuum filtration and oven drying, the film (E-BC-100 A/B) was manufactured by alkali treatment (2% w/w NaOH solution for 30 min) and bleaching.

Referring to FIG. 10B, the film (E-BC-300 R) was manufactured by simultaneously performing vacuum filtration and oven drying of the BC-NC-E dispersion.

When vacuum filtration and oven drying were performed at the same time, there are advantages that the time required for manufacturing the film may be reduced and physical properties increased while applying a pressure during drying.

In order to improve the transparency and physical properties of the film (E-BC-300 R) manufactured through vacuum filtration and oven drying, the film (E-BC-300 A) was manufactured by alkali treatment (2% w/w NaOH solution for 30 min).

Also, in order to improve the transparency and physical properties of the film (E-BC-300 R) manufactured through vacuum filtration and oven drying, the film (E-BC-300 A/B) was manufactured by alkali treatment (2% w/w NaOH solution for 30 min) and bleaching.

Referring to FIG. 10C, the film (E-BC-500 R) was manufactured by simultaneously performing vacuum filtration and oven drying of the BC-NC-E dispersion.

When vacuum filtration and oven drying were performed at the same time, there are advantages that the time required for manufacturing the film may be reduced and physical properties increased while applying a pressure during drying.

In order to improve the transparency and physical properties of the film (E-BC-500 R) manufactured through vacuum filtration and oven drying, the film (E-BC-500 A) was manufactured by alkali treatment (2% w/w NaOH solution for 30 min).

Also, in order to improve the transparency and physical properties of the film (E-BC-500 R) manufactured through vacuum filtration and oven drying, the film (E-BC-500 A/B) was manufactured by alkali treatment (2% w/w NaOH solution for 30 min) and bleaching.

In case of alkali treatment and bleaching on the bacterial nanocellulose film, by-products such as protein and nucleic acid were removed and the film became transparent.

With respect to the manufactured films (E-BC-R, E-BC-A, and E-BC-A/B), the transmittance values were measured in a wavelength band of 400 to 600 nm to confirm the transparency.

In addition, in order to set a control for the BC-NC-E film in Comparative Example, a film was manufactured using TOCN, which has been studied the most. The film was manufactured by vacuum filtration and oven drying under the same method and conditions as those of the BC-NC-E film.

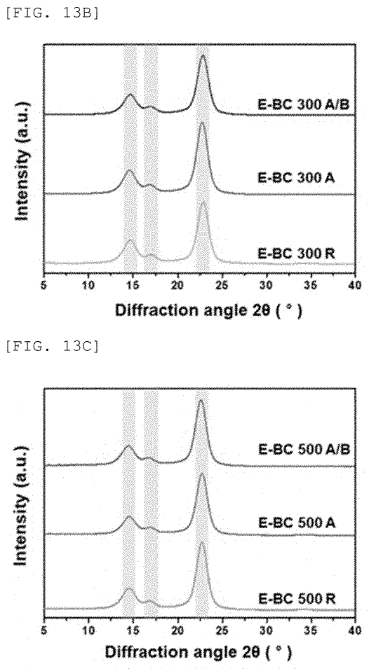

FIG. 11 shows a UV-Vis transmittance graph of the bacterial nanocellulose transparent film according to Example 2.

Referring to FIG. 11, as a result of measuring the transmittance, it was confirmed that the transmittance value increased as the alkali treatment and bleaching were performed based on the transmittance value in a 600 nm wavelength band. In addition, in the case of the E-BC-100-A/B film, compared with the transmittance value of the TOCN film manufactured through vacuum filtration and oven drying, it was confirmed that the E-BC-100-A/B film had a larger thickness, but had similar transmittance.

The results were shown in Table 1.3.

TABLE 1.3
Characterization data for bacterial cellulose film (E-BC film) made by
vacuum filtration and oven drying. Including TOCN film as reference.

| | Thickness | % | CrI | T_{d onset} | T_{d max} |
|---|---|---|---|---|---|
| Film | (μm) | T₆₀₀^{a} | (%) ^{b} | (° C.) ^{c} | (° C.) ^{d} |
| TOCN | 63 | 77 | 65 | 215 | 242 297 |
| E-BC 100 R | 80 | 70 | 91 | 236 | 344 |
| E-BC 100 A | 78 | 73 | 91 | 231 | 337 |
| E-BC 100 A/B | 77 | 77 | 91 | 247 | 337 |
| E-BC 300 R | 82 | 55 | 93 | 217 | 339 |
| E-BC 300 A | 80 | 62 | 94 | 226 | 337 |
| E-BC 300 A/B | 80 | 65 | 93 | 253 | 337 |
| E-BC 500 R | 85 | 55 | 94 | 209 | 334 |
| E-BC 500 A | 80 | 56 | 93 | 226 | 337 |
| E-BC 500 A/B | 83 | 61 | 94 | 257 | 339 |

^{a}The value at a wavelength was at 600 nm using UV-Vis spectrometer.
^{b} The crystallinity index (CrI) of the bacterial cellulose was calculated from XRD data using equation reported by Segal et al.: CrI (%) = [(I₀₀₂ − I [symbol] )/I₀₀₂] × 100, where I₀₀₃ is the peak intensity of the main crystalline plane (002) lattice diffraction at 2 θ = 22-23° and I [symbol] is the diffraction intensity of the amorphous fraction at 2 θ = 18-19°
^{c} 5% weight loss determined by TGA after 100° C.
^{d} The temperature of the maximum degradation rate using DTG. [symbol]
indicates data missing or illegible when filed

In addition, absorbance was measured to confirm whether by-products other than cellulose were removed. The wavelength band of 200 to 400 nm was measured to observe a change at 260 to 280 nm, which was an intrinsic peak of absorbance of protein and nucleic acid, which were representative by-products of bacterial cellulose.

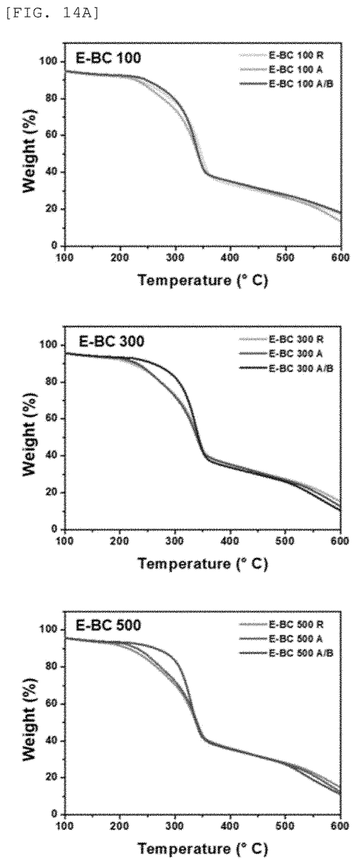

FIG. 12A shows UV-Vis absorption spectra graphs of bacterial nanocellulose transparent films formed by irradiating 100 kGy electron beam, FIG. 12B shows UV-Vis absorption spectra graphs of bacterial nanocellulose transparent films formed by irradiating 300 kGy electron beam, and FIG. 12C shows UV-Vis absorption spectra graphs of bacterial nanocellulose transparent films formed by irradiating 500 kGy electron beam, which are all manufactured according to Example 2.

Referring to FIG. 12A˜FIG. 12C, as a result of measuring UV-Vis absorption spectra, in the case of alkali treatment and bleaching, the overall absorbance in a wavelength band of 200 to 400 nm decreased, and in particular, the intensity decreased in a wavelength band of 260 to 280 nm. Through this, it was confirmed that the film became transparent as the color faded, and by-products such as protein and nucleic acid were removed.

In addition, XRD was measured to determine whether alkali treatment and bleaching had an effect on crystallinity.

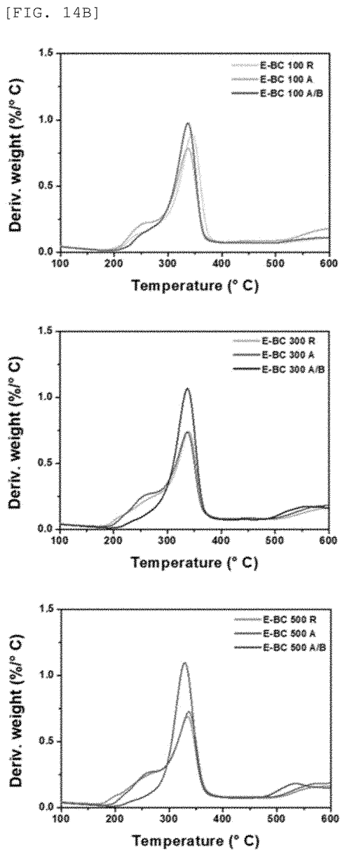

FIG. 13A shows XRD graphs of bacterial nanocellulose raw films, alkali-treated bacterial nanocellulose films and alkali-treated and bleached bacterial nanocellulose films formed by irradiating 100 kGy electron beam, FIG. 13B shows XRD graphs of bacterial nanocellulose raw films, alkali-treated bacterial nanocellulose films and alkali-treated and bleached bacterial nanocellulose films formed by irradiating 300 kGy electron beam, and FIG. 13C shows XRD graphs of bacterial nanocellulose raw films, alkali-treated bacterial nanocellulose films and alkali-treated and bleached bacterial nanocellulose films formed by irradiating 500 kGy electron beam, which are all manufactured according to Example 2.

Referring to FIG. 13A˜FIG. 13C and Table 1.3, it was confirmed that the degree of crystallization (CrI) was not reduced, and an XRD peak of bacterial cellulose was also maintained the same.

When the cellulose was treated with alkali, mercerization occurred and a structure of the cellulose was changed (cellulose I→cellulose II). In this case, the degree of crystallization was greatly reduced, and the physical properties were reduced.

In particular, the degree of crystallization greatly affected an oxygen barrier property and mechanical properties. However, the result was obtained that even if the manufactured film was alkali-treated, the structure of the cellulose was not changed and the degree of crystallization (CrI) was maintained.

In addition, it was confirmed that the film did not a negative effect on the degree of crystallization and the crystal structure even by bleaching.

In order to confirm the thermal stability of the film, the thermal stability was confirmed through TGA and DTG graphs.

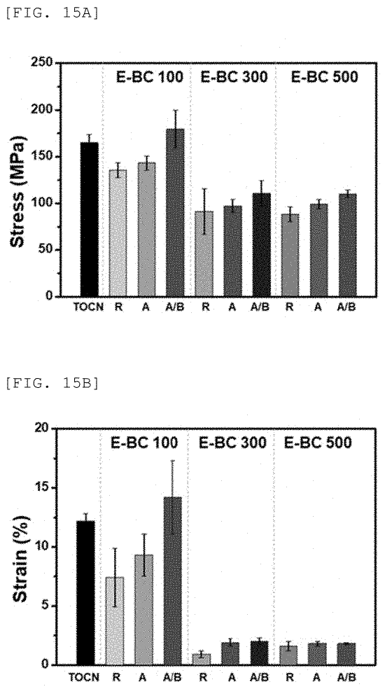

FIG. 14A shows TGA graphs of a bacterial nanocellulose raw film, an alkali-treated bacterial nanocellulose film, and an alkali-treated and bleached bacterial nanocellulose film and FIG. 14B shows DTA graphs of a bacterial nanocellulose raw film, an alkali-treated bacterial nanocellulose film, and an alkali-treated and bleached bacterial nanocellulose film, which are all manufactured according to Example 2.

Referring to FIG. 14A, FIG. 14B and Table 1.3, it was confirmed that a Td onset of the E-BC-A/B film was increased as compared with E-BC-R. The reason for the increase in Td onset was that by-products (protein, nucleic acid, etc.) were removed during the alkali treatment and bleaching processes, and as a result, an area for hydrogen bonding between celluloses was increased so that the number of hydrogen bonds increased.

Tensile strength was measured to determine mechanical properties.

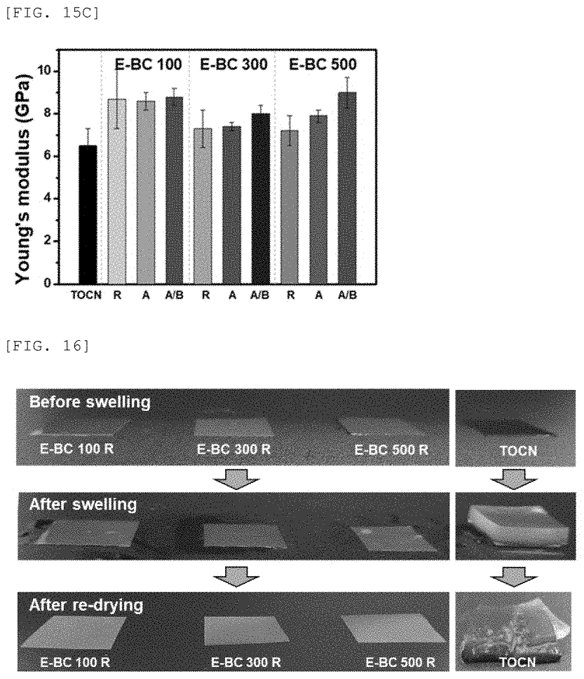

FIG. 15A shows Stress graphs of a TOCN film, a bacterial nanocellulose raw film, an alkali-treated bacterial nanocellulose film, and an alkali-treated and bleached bacterial nanocellulose film, FIG. 15B shows Strain graphs of a TOCN film, a bacterial nanocellulose raw film, an alkali-treated bacterial nanocellulose film, and an alkali-treated and bleached bacterial nanocellulose film, and FIG. 15C shows Young's modulus graphs of a TOCN film, a bacterial nanocellulose raw film, an alkali-treated bacterial nanocellulose film, and an alkali-treated and bleached bacterial nanocellulose film, which are all manufactured according to an embodiment of the present disclosure.

Table 1.4 showed physical property data of the bacterial nanocellulose film.

TABLE 1.4
The result of tensile mechanical properties of TOCN and E-BC film.

| | Stress, [symbol] | Strain at break, [symbol] | Young's modulus, [symbol] |
|---|---|---|---|
| Film | (MPa) | (%) | (GPa) |
| TOCN | 165.0 ± 9.2 | 12.2 ± 0.6 | 6.5 ± 0.8 |
| E-BC 100 R | 135.8 ± 8.1 | 7.4 ± 2.5 | 8.6 ± 1.4 |
| E-BC 100 A | 143.4 ± 7.7 | 9.3 ± 1.8 | 8.6 ± 0.4 |
| E-BC 100 A/B | 179.5 ± 20.1 | 14.2 ± 3.1 | 8.8 ± 0.4 |
| E-BC 300 R | 91.3 ± 24.3 | 0.9 ± 0.3 | 7.3 ± 0.9 |
| E-BC 300 A | 97.1 ± 6.9 | 1.9 ± 0.3 | 7.4 ± 0.2 |
| E-BC 300 A/B | 110.7 ± 13.9 | 2.0 ± 0.3 | 8.0 ± 0.4 |
| E-BC 500 R | 88.3 ± 7.8 | 1.6 ± 0.4 | 7.2 ± 0.7 |
| E-BC 500 A | 99.2 ± 5.0 | 1.8 ± 0.2 | 7.9 ± 0.3 |
| E-BC 500 A/B | 110.2 ± 4.2 | 1.8 ± 0.1 | 9.0 ± 0.7 |

[symbol]

indicates data missing or illegible when filed

Referring to FIG. 15A˜FIG. 15C and Table 1.4, it was confirmed that physical properties were increased in the film under all conditions (100, 300, and 500 kGy) when the film was alkali-treated and bleached. The reason was that the number of hydrogen bonds increased as the by-products were removed, as the same reason as the increased thermal stability.

Among them, in the case of a Young's modulus value, the film under all conditions manufactured with bacterial cellulose had a higher value than the value of the TOCN film manufactured by the same method.

In particular, in the case of the E-BC-100 A/B film, it was confirmed that all values of stress, strain, and Young's modulus were higher than those of the TOCN film.

In order to confirm the stability of the film to moisture, the swelling ratio was measured after immersion in ultrapure water.

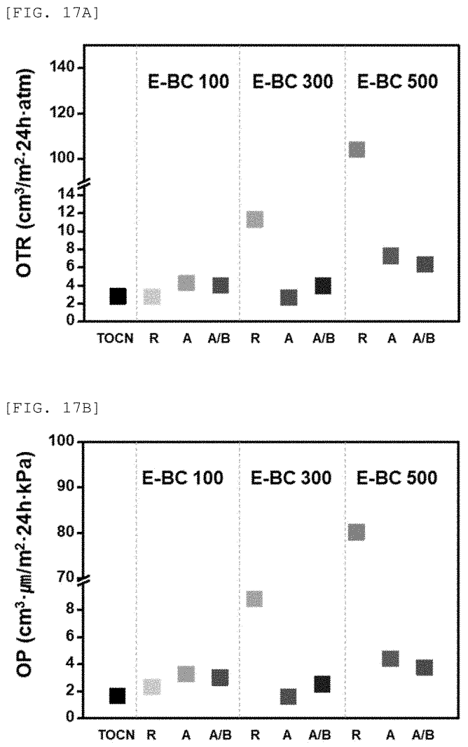

FIG. 16 shows swelling test images of a TOCN film and a bacterial nanocellulose film according to an embodiment of the present disclosure.

Table 1.5 showed swelling data of the bacterial nanocellulose film.

TABLE 1.5

| | Before immersion | After immersion | Swelling ratio |
|---|---|---|---|
| Film | (g) | (g) | (%) |
| TOCN | 0.06 | 6.14 | 9635 |
| E-BC 100 R | 0.07 | 0.19 | 172 |
| E-BC 100 A | 0.10 | 0.31 | 220 |
| E-BC 100 A/B | 0.08 | 0.23 | 202 |
| E-BC 300 R | 0.06 | 0.14 | 130 |
| E-BC 300 A | 0.03 | 0.09 | 146 |
| E-BC 300 A/B | 0.05 | 0.12 | 141 |
| E-BC 500 R | 0.06 | 0.13 | 126 |
| E-BC 500 A | 0.05 | 0.14 | 167 |
| E-BC 500 A/B | 0.05 | 0.12 | 151 |

Referring to FIG. 16 and Table 1.5, the TOCN film was swelled by 9,635% of an initial weight. In contrast, in the case of the bacterial nanocellulose film, the highest ratio was swelled to 220%.

As a result, it was confirmed that compared with the TOCN film, the bacterial nanocellulose film had a significantly low swelling ratio.

In addition, in the case of the TOCN film, it was impossible to recover the film because the shape of the film collapsed in the immersion condition. On the other hand, it was confirmed that the bacterial nanocellulose film was recoverable while the shape after re-drying was maintained as it is.

Table 1.6 showed physical property data of the bacterial nanocellulose film after re-drying.

TABLE 1.6
The result of tensile mechanical properties of TOCN and BC
film after swelling and re-drying.

| | | | Strain at | | Young's | |
|---|---|---|---|---|---|---|
| | Stress, [symbol] | | break, [symbol] | | modulus, [symbol] | |
| Film | (MPa) | | (%) | | (GPa) | |
| TOCN [symbol] | 165.0 | → — | 12.2 | → — | 6.5 | → — |
| E-BC 100 R | 135.8 | → 71.5 | 7.4 | → 2.9 | 8.6 | → 7.9 |
| E-BC 100 A | 143.4 | → 121.3 | 9.3 | → 7.5 | 8.6 | → 7.9 |
| E-BC 100 A/B | 179.5 | → 152.7 | 14.2 | → 8.3 | 8.8 | → 7.8 |
| E-BC 300 R | 91.3 | → 47.9 | 0.9 | → 1.6 | 7.3 | → 6.0 |
| E-BC 300 A | 97.1 | → 54.6 | 1.9 | → 2.4 | 7.4 | → 7.0 |
| E-BC 300 A/B | 110.7 | → 62.3 | 2.0 | → 2.3 | 8.0 | → 7.6 |
| E-BC 500 R | 88.3 | → — | 1.6 | → — | 7.2 | → — |
| E-BC 500 A | 99.2 | → 43.8 | 1.8 | → 2.5 | 7.9 | → 7.4 |
| E-BC 500 A/B | 110.2 | → 44.9 | 1.8 | → 2.8 | 9.0 | → 7.3 |

[symbol]

indicates data missing or illegible when filed

Referring to Table 1.6, as a result of measuring the physical properties of the E-BC film after re-drying, all mechanical properties were decreased overall. However, in the case of the E-BC-100 A/B film, it was confirmed that the film had a higher Young's modulus than that of the TOCN film while having a stress value similar to that of the TOCN film.

### <Application Example> Bacterial Nanocellulose Transparent Film as Food Packaging Material

In order to utilize a film as a packaging material, important physical properties were oxygen, moisture and UV barrier properties. These three factors directly affected foods, causing spoilage and lipid fructose. In the present disclosure, in order to determine whether the manufactured bacterial nanocellulose film can be used as a food packaging material, the barrier properties against oxygen and UV were studied among the three factors. First, in order to determine the oxygen barrier property, an oxygen transmission rate (OTR) and oxygen permeability (OP) were measured by measuring oxygen permeability.

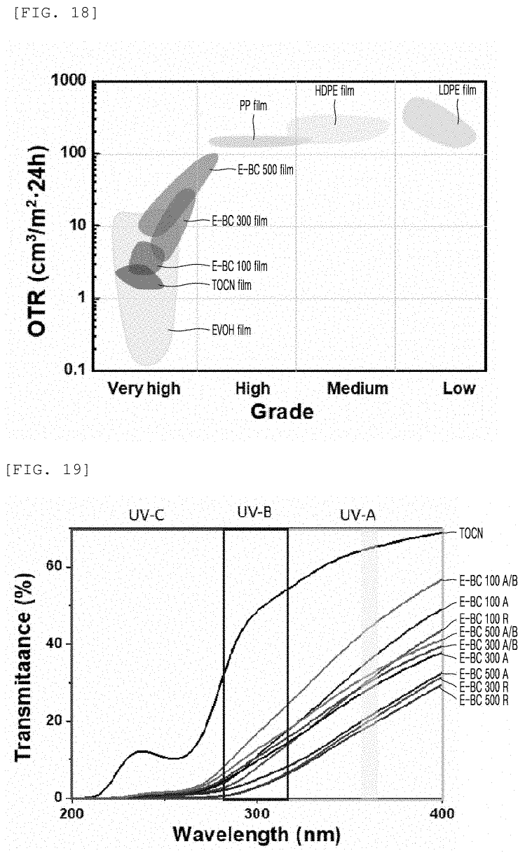

FIG. 17A shows oxygen transmission rate (OTR) graphs of a TOCN film, a bacterial nanocellulose raw film, an alkali-treated bacterial nanocellulose film, and an alkali-treated and bleached bacterial nanocellulose film and FIG. 17B shows oxygen permeability (OP) graphs of a TOCN film, a bacterial nanocellulose raw film, an alkali-treated bacterial nanocellulose film, and an alkali-treated and bleached bacterial nanocellulose film, which are all manufactured according to an embodiment of the present disclosure.

Table 1.7 showed oxygen permeability data of a TOCN film, a bacterial nanocellulose raw film, an alkali-treated bacterial nanocellulose film, and an alkali-treated and bleached bacterial nanocellulose film.

TABLE 1.7
Oxygen barrier properties of TOCN and E-BC film at
23° C. and RH 0%.

| | CrI | OTR | OP |
|---|---|---|---|
| Film | (%) | (cm³/m² · 24 h · atm) | (cm²/μm/m² · 24 h · kPa) |
| TOCN | 67 | 2.78 | 1.65 |
| E-BC 100 R | 91 | 2.77 | 2.32 |
| E-BC 100 A | 91 | 4.29 | 3.26 |
| E-BC 100 A/B | 91 | 4.01 | 3.01 |
| E-BC 300 R | 93 | 11.3 | 8.81 |
| E-BC 300 A | 94 | 2.66 | 1.60 |
| E-BC 300 A/B | 93 | 3.94 | 2.53 |
| E-BC 500 R | 94 | 104.00 | 80.13 |
| E-BC 500 A | 93 | 7.29 | 4.39 |
| E-BC 500 A/B | 94 | 6.33 | 3.75 |

Referring to FIG. 17A and FIG. 17B and Table 1.7, when comparing the values with those of a TOCN film having excellent an oxygen barrier property, it was confirmed that the films had similar values except for the films of E-BC-300 R and E-BC-500 R.

This is because the degree of crystallization (CrI) of the films of bacterial cellulose is high. Oxygen cannot pass through a crystal region. Therefore, the higher the CrI (%), the lower the oxygen permeability.

However, there is a large difference in degree of crystallization between the TOCN film (65 to 67%) and the E-BC film (91 to 94%), but the reason why the TOCN film has similar values is that the TOCN film contain more moisture than the E-BC films.

In addition, the more moisture in the film, the lower the oxygen permeability.

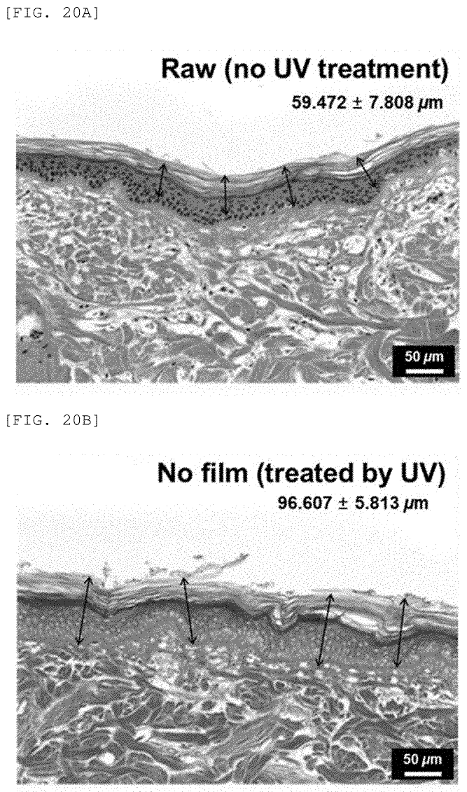

FIG. 18 shows oxygen transmission rate (OTR) range graphs of a bacterial nanocellulose transparent film and various plastic films according to an embodiment of the present disclosure.

Referring to FIG. 18 and Table 1.7, when comparing the measured values with an oxygen permeability value of a commercial polymer film of the document of Jinwu Wang et al., 2018, it was confirmed that the oxygen barrier property of the E-BC films was higher than those of other polymer films except for EVOH.

The document of Jinwu Wang et al., 2018 was Jinwu W., Douglas J. G., Nicole M. S., Douglas W. B., Mehdi T., Zhiyong C., (2018). Moisture and oxygen barrier properties of cellulose nanomaterial based films. ACS Sustainable Chem. Eng, 6, 49-70.

Then, total two experiments were conducted to determine the UV barrier property.

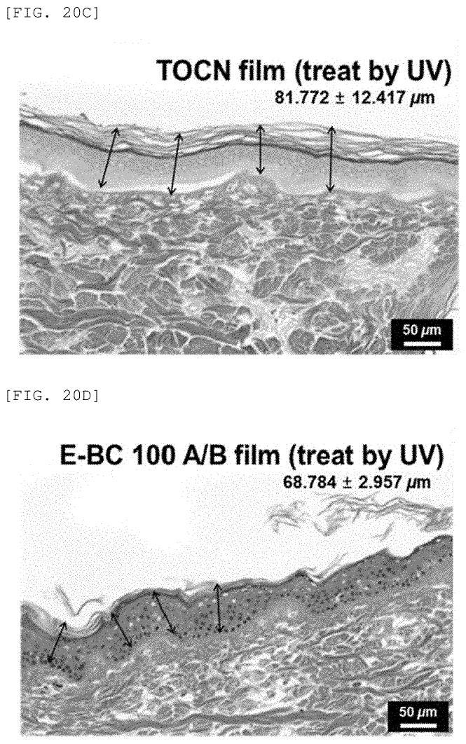

FIG. 19 shows UV-Vis transmittance spectra graphs of a TOCN film, a bacterial nanocellulose raw film, an alkali-treated bacterial nanocellulose film, and an alkali-treated and bleached bacterial nanocellulose film according to Example 2.

Referring to FIG. 19, as a result of measuring the transmittance of each film in the UV-A, B, and C wavelength bands, it was confirmed that the E-BC film under all conditions had a lower transmittance than the TOCN film.

FIG. 20A shows images measured thickness changes of the epidermal layers of artificial skin not irradiated with a UV lamp of 365 nm used as a UV barrier property index, FIG. 20B shows images measured thickness changes of artificial skin irradiated with the UV lamp of 365 nm, FIG. 20C shows images measured thickness changes of artificial skin covered with a TOCN film irradiated with the UV lamp of 365 nm, and FIG. 20D shows images measured thickness changes of artificial skin covered with an alkali-treated and bleached bacterial nanocellulose film irradiated with the UV lamp of 365 nm for 72 hours, according to Example 2.

Referring to FIG. 20A˜FIG. 20D, after irradiating artificial skin (FCM) for 72 hours using a UV lamp in a wavelength band of 365 nm, a change in thickness of the epidermal layer was measured.

The conditions were measured under total four conditions as FCM (Raw) without any treatment, FCM (No film) UV-treated for 72 hours without covering a film, FCM (TOCN film) UV-treated and covered with a TOCN film, and FCM (E-BC-100 A/B film) UV-treated and covered with a E-BC-100 A/B film having best physical properties, but having highest transmittance in the UV-A, B, and C wavelength bands among the E-BC films.

As a result, in the case of Raw without any treatment, it was measured that the epidermal layer had an average of 59.4 μm. On the other hand, it was confirmed that the thickness of the epidermal layer of No film was 96.6 μm increased by 1.66 times after irradiation with UV for 72 hours.

Through this, it was confirmed that the epidermis layer became thick when irradiated with UV once again through the experimental results, and based on this, the UV barrier property of the nanocellulose film was confirmed.

As a result of the experiment, the thickness of the epidermal layer of the FCM covered with the TOCN film and irradiated with UV was 81.8 μm increased by 1.38 times. On the other hand, in the case of the E-BC-100 A/B film, the thickness of the epidermal layer was 68.8 μm increased by 1.16 times. The reason why the E-BC film has a better UV barrier property than the TOCN film is that the E-BC film generates a chromophore by electron beam treatment and has a yellowish color. This is because the UV barrier property was better as the film has the color.

As can be seen from the transmittance of the film in a 200 to 400 nm wavelength band, the more the alkali treatment and bleaching, the higher the transmittance in the UV wavelength band. The reason is that when alkali treatment and bleaching are performed, the film becomes transparent while discoloring.

However, when comparing the study results through artificial skin with the TOCN film, it was confirmed that the E-BC-100 A/B film, which has the highest transmittance among the E-BC films, has a better UV barrier property than the TOCN film. Through this, it was possible to obtain the result that the UV barrier property of the E-BC film was superior to that of the TOCN film.

As a result, the bacterial cellulose film manufactured after electron beam treatment compensated for transparency and a low oxygen barrier property as disadvantages of eco-friendly plastics under study, and had high mechanical properties and thermal stability. Based on this, when coating treatment and the like are applied to eco-friendly plastics, a better eco-friendly packaging material can be manufactured through the E-BC films.

So far, although the specific embodiments of the bacterial nanocellulose transparent film according to the present disclosure, the manufacturing method thereof, and the packaging material using the same have been described, it is apparent that various modifications can be made without departing from the scope of the present disclosure.

Therefore, the scope of the present disclosure should not be limited to the exemplary embodiments and should be defined by the appended claims and equivalents to the appended claims.

In other words, the embodiments described above are illustrative in all aspects and should be understood as not being restrictive, and the scope of the present disclosure is represented by appended claims to be described below rather than the detailed description, and it is to be interpreted that the meaning and scope of the appended claims and all changed or modified forms derived from the equivalents thereof are included within the scope of the present disclosure.

What is claimed is:

1. A bacterial nanocellulose transparent film having a barrier property formed by a transparent film with a multilayer structure of bacterial nanocellulose, wherein
the bacterial nanocellulose is formed by electron beam irradiation and mechanical treatment on wet bacterial cellulose,
the bacterial nanocellulose comprises nanocellulose consisting of cellulose nanofibers (CNF) aggregated with one or more cellulose nanofibrils,
the cellulose nanofibers (CNF) has a carboxylate group,
the multilayer structure of the transparent film is formed by filtering and drying a dispersion of the bacterial nanocellulose,
the transparent film is alkali-treated and bleached to increase a mechanical property and a transparency, the mechanical property includes an Young's modulus, a tensile stress, or a tensile strain, and
the barrier property of the transparent film includes an oxygen barrier property, a moisture barrier property, or a UV barrier property.

2. The bacterial nanocellulose transparent film of claim 1, wherein a transmittance at 400 nm to 600 nm of the bacterial nanocellulose transparent film is 50% to 90%.

3. The bacterial nanocellulose transparent film of claim 1, wherein in the oxygen barrier property of the bacterial nanocellulose transparent film, an oxygen transmission rate (OTR; cm³/m²·24 h·atm) is 2.0 to 110 at 23° C. and 0% relative humidity.

4. The bacterial nanocellulose transparent film of claim 1, wherein the swelling ratio before and after immersion in water of the bacterial nanocellulose transparent film used as a moisture barrier property index is 100% to 250%.

5. The bacterial nanocellulose transparent film of claim 1, wherein a UV-A (315 to 400 nm) transmittance of the bacterial nanocellulose transparent film used as a UV barrier property index is 3% to 60%.

6. The bacterial nanocellulose transparent film of claim 1, wherein the change in thickness of the epidermal layer after irradiating artificial skin with a UV lamp of 365 nm used as a UV barrier property index of the bacterial nanocellulose transparent film for 72 hours is 1.05 times to 1.20 times.

7. The bacterial nanocellulose transparent film of claim 1, wherein the Young's modulus is 6.6 GPa to 10.0 GPa, the tensile stress is 80 MPa to 200 MPa, or the tensile strain is 1% to 20%.

8. The bacterial nanocellulose transparent film of claim 1, wherein the cellulose nanofibers (CNF) include a crystalline portion and an amorphous portion constituting a crystal system, and
the cellulose nanofibers (CNF) have a diameter of 2 nm to 40 nm and a length of 500 nm to 20 μm.

9. The bacterial nanocellulose transparent film of claim 1, wherein the bacterial nanocellulose exhibits a zeta potential of −50 mV to +50 mV.

10. The bacterial nanocellulose transparent film of claim 1, wherein the bacterial nanocellulose has a light transmittance at 400 nm to 600 nm of 80% to 98%.

11. The bacterial nanocellulose transparent film of claim 1, wherein a degree of polymerization (DP) of the bacterial nanocellulose is 1 to 200.

12. The bacterial nanocellulose transparent film of claim 1, wherein the shape of the cellulose nanofibers is at least one shape selected from the group consisting of filament fibers, staple fibers, needle fibers, entangled fibers, and linear fibers.

13. The bacterial nanocellulose transparent film of claim 1, wherein the bacterial nanocellulose transparent film is a transparent film with a multilayer structure of bacterial nanocellulose, wherein
the bacterial nanocellulose is formed by electron beam irradiation and mechanical treatment on wet bacterial cellulose,
the cellulose nanofibers (CNF) have a carboxylate group, and
the cellulose nanofibers (CNF) have a diameter of 2 nm to 40 nm and a length of 500 nm to 20 μm.

14. The bacterial nanocellulose transparent film of claim 1, wherein a suspension of the bacterial nanocellulose is re-dried to a powder through a spray dryer, the powder of the dried bacterial nanocellulose is redispersed from a powder to a dispersion.

15. A manufacturing method of a bacterial nanocellulose transparent film comprising:
(1) preparing a bacterial nanocellulose dispersion consisting of cellulose fibers (CNF) having a carboxylate group by irradiating electron beam on wet bacterial cellulose; and
(2) forming a bacterial nanocellulose transparent film by vacuum filtration and oven drying of the bacterial nanocellulose dispersion.

16. The manufacturing method of the bacterial nanocellulose transparent film of claim 15, wherein the preparing of the bacterial nanocellulose dispersion in step (1) comprises
(a) separating the wet bacterial cellulose into cellulose fibers having a carboxylate group by irradiating the electron beam;
(b) alkalizing the cellulose fibers having the carboxylate group by adding an alkali compound;
(c) preparing cellulose nanofibers having a carboxylate group by separating the alkalized cellulose fibers having the carboxylate group with a high-pressure machine; and
(d) preparing a nanocellulose dispersion consisting of cellulose nanofibers (CNF) having a carboxylate group by adding carbon dioxide (CO₂) to the cellulose nanofibers having the carboxylate group, neutralizing and centrifuging.

17. The manufacturing method of the bacterial nanocellulose transparent film of claim 15, wherein the forming of the bacterial nanocellulose transparent film in step (2) further comprises oven-drying the bacterial nanocellulose dispersion, alkali-treating by adding an alkali compound, and then bleaching.

18. The manufacturing method of the bacterial nanocellulose transparent film of claim 15, wherein the beam intensity of the electron beam is 200 kGy to 3000 kGy.

19. The manufacturing method of the bacterial nanocellulose transparent film of claim 15, wherein the manufacturing method of the bacterial nanocellulose transparent film is a manufacturing method of a bacterial nanocellulose transparent film with a multilayer structure of the bacterial nanocellulose after a preparation method of bacterial nanocellulose consisting of cellulose nanofibers, the preparation method of bacterial nanocellulose consisting of cellulose nanofibers comprising:
(1) separating bacterial cellulose fibers (BCF) having a carboxylate group from the bacterial cellulose by irradiating electron beam to wet bacterial cellulose;
(2) alkalizing the bacterial cellulose fibers having the carboxylate group by adding an alkali compound;
(3) preparing bacterial cellulose nanofibers having a carboxylate group by separating the alkalized bacterial cellulose fibers (BCF) having the carboxylate group with a high-pressure machine device;
(4) preparing a bacterial nanocellulose dispersion consisting of bacterial cellulose nanofibers (BCNF) having a carboxylate group by adding carbon dioxide (CO₂) to the bacterial cellulose nanofibers having the carboxylate group, neutralizing and centrifuging; and
(5) preparing bacterial nanocellulose consisting of the bacterial cellulose nanofibers (BCNF) having the carboxylate group by drying the bacterial nanocellulose dispersion.

20. A packaging material including a food packaging material or an electronic product packaging material using a bacterial nanocellulose transparent film.
